(19) United States
(12) Patent Application Publication
(10) Pub. No.: US 2007/0173090 A1
(43) Pub. Date: Jul. 26, 2007

(54) BATTERY PACK

(76) Inventors: Todd W. Johnson, Wauwatosa, WI (US); Dennis J. Grzybowski, New Berlin, WI (US); Mark A. Kubale, West Bend, WI (US); Jay J. Rosenbecker, Menomonee Falls, WI (US); Gary D. Meyer, Waukesha, WI (US); Jeffrey M. Zeiler, Delafield, WI (US)

Correspondence Address: MICHAEL, BEST & FREIDRICH LLP, 100 EAST WISCONSIN AVENUE, SUITE 3300, MILWAUKEE, WI, 53202, US

(21) Appl. No.: 11/621,704

(22) Filed: Jan. 10, 2007

Related U.S. Application Data
(60) Provisional application No. 60/757,693, filed on Jan. 10, 2006.

(51) Int. Cl. H01R 13/62

(52) U.S. Cl. 439/157

(57) ABSTRACT

A battery pack that is configured to be coupled to an electrical device comprises a housing, at least one battery cell positioned in the housing, and a terminal assembly configured to electrically connect the battery cell to the electrical device. The battery pack also includes a locking assembly that is configured to engage the electrical device. The locking assembly includes a locking member, an actuator coupled to the locking member, and a biasing member. The locking member is movable about a pivot point between a first position to engage the electrical device and a second position. The actuator is actuatable to move the locking member from the first position to the second position. The biasing member biases the locking member to the first position.

### RELATED APPLICATION

This application claims priority to co-pending U.S. Provisional Patent Application Ser. No. 60/757,693, filed Jan. 10, 2006, the entire contents of which are incorporated herein by reference.

### FIELD OF THE INVENTION

The present invention generally relates to battery packs and, more particularly, to power tool battery packs.

### BACKGROUND OF THE INVENTION

Typically, electrical equipment, such as, for example, a cordless power tool, is powered by a rechargeable battery. The battery may be periodically charged in a compatible battery charger.

### SUMMARY OF THE INVENTION

The following summary sets forth certain exemplary embodiments of the invention. It does not set forth all such embodiments and is not limiting of embodiments of the invention.

FIGS. 36-38 illustrate an existing battery pack 230. The existing battery pack 230 includes a housing 242 and at least one rechargeable battery cell 246 (shown in FIGS. 39-40) supported by the housing 242. In the illustrated construction, the existing battery pack 230 is an 18V battery pack including (see FIGS. 39-40) fifteen approximately 1.2V battery cells 246 connected in series. The battery cells 246 are a rechargeable battery cell chemistry type, such as, for example, NiCd or NiMH.

As shown in FIGS. 39-40, in the existing battery pack 230, each battery cell 246 is generally cylindrical and extends along a cell axis 250 parallel to the cylindrical outer cell wall. In the existing battery pack 230, the cell axes 250 are parallel to one another. Also, in the existing battery pack 230, each battery cell 246 has a cell length 252 which is about two times the cell diameter 254. In the illustrated construction, each battery cell 246 has a length of about forty-six millimeters (46 mm) and a diameter of about twenty-three millimeters (23 mm).

The existing battery pack 230 is connectable to (see FIG. 12) a battery charger 38, and the battery charger 38 is operable to charge the existing battery pack 230. The existing battery pack 230 is connectable to electrical equipment, such as, for example, a power tool 34 (shown in FIG. 11A), to power the power tool 34. As shown in FIGS. 36-38, the housing 242 provides a support portion 250 for supporting the existing battery pack 230 on an electrical device. In the illustrated construction, the support portion 250 provides (see FIG. 36) a C-shaped cross section which is connectable to a complementary T-shaped cross section support portion on the electrical device (the support portion on the power tool 34 (shown in FIG. 11B) and/or the battery support portion on the battery charger 38 (shown in FIG. 12).

The existing battery pack 230 includes (see FIGS. 36-37 and 39-40) a terminal assembly 286 operable to electrically connect battery cells 246 to a circuit in the electrical device. The terminal assembly 286 includes a positive battery terminal 298, a ground terminal 302, and a sense terminal 306. As illustrated in FIGS. 39-40, the terminals 298 and 302 are connected to the opposite ends of the cell or series of cells 246. The sense terminal 306 is connected to (see FIG. 40) an electrical component 314 which is connected in the circuit of the existing battery pack 230. In the illustrated construction, the electrical component 314 is a temperature-sensing device or thermistor to communicate the temperature of the existing battery pack 230 and/or of the battery cells 246.

The present invention provides a battery pack which substantially alleviates one or more independent problems with the above-described and other existing battery packs. In some aspects and in some constructions, the present invention provides a battery pack including two cells which are positioned in non-parallel relation to each other. In some aspects, the two cells are positioned in normal relation to each other.

More particularly, in some aspects and in some constructions, the present invention provides a battery pack including a housing, a first cell extending along a first cell axis, and a second cell extending along a second cell axis, the first cell and the second cell being supported by the housing in an orientation in which the first cell axis is non-parallel to the second cell axis. In some aspects and in some constructions, the first cell axis is normal to the second cell axis.

Also, in some aspects and in some constructions, the present invention provides a method of assembling a battery pack, the method including the acts of providing a battery pack housing, supporting a first cell with the housing, and supporting a second cell with the housing in non-parallel relation to the first cell. In some aspects, the act of supporting the second cell includes supporting the second cell in normal relation to the first cell.

In addition, in some aspects and in some constructions, the present invention provides a battery pack including a plurality of cells, a sensor for sensing the voltage of a first group of the plurality of cells, a sensor for sensing the voltage of a second group of the plurality of cells, and a controller for comparing the voltage of the first group to the voltage of the second group to determine if one of the plurality of cells is at or below a voltage.

Further, in some aspects and in some constructions, the present invention provides a method of determining a voltage of a cell of a battery pack, the battery pack including a plurality of cells, the method including the acts of sensing the voltage of a first group of the plurality of cells, sensing the voltage of a second group of the plurality of cells, and comparing the voltage of the first group to the voltage of the second group to determine if one of the plurality of cells is at or below a voltage.

Also, in some aspects and in some constructions, the present invention provides a battery pack including a housing, a cell supported by the housing, a FET connected to the cell, and a heat sink in heat-transfer relationship with the FET.

In addition, in some aspects and in some constructions, the present invention provides a method of assembling a battery pack, the method including the acts of providing a housing, supporting a cell with the housing, supporting a FET with the housing, connecting the FET to the cell, and supporting a heat sink in heat-transfer relationship with the FET.

Further, in some aspects and in some constructions, the present invention provides a battery including a housing supportable by an electrical device, a cell supported by the housing and connectable to the electrical device and a locking assembly for locking the battery to the electrical device. The locking assembly includes a locking member supported by the housing for movement between a locked position, in which the battery is locked to the electrical device, and an unlocked position, an actuator supported by the housing and operable to move the locking member between the locked position and the unlocked position and a biasing member operable to bias the locking member to the locked position, the biasing member being fixed between the actuator and the housing and retaining the actuator in a position relative to the housing.

In another embodiment, a battery pack configured to be coupled to an electrical device comprises a housing, at least one battery cell positioned in the housing, and a terminal assembly configured to electrically connect the battery cell to the electrical device. The battery pack also comprises a locking assembly that is configured to engage the electrical device. The locking assembly includes a locking member, an actuator coupled to the locking member, and a biasing member. The locking member is movable about a pivot point between a first position to engage the electrical device and a second position. The actuator is actuatable to move the locking member from the first position to the second position. The biasing member biases the locking member to the first position.

In yet another embodiment, a system comprises an electrical device and a battery pack. The electrical device has a circuit and a support portion that defines at least one recess. The battery pack is configured to be selectively coupled to the electrical device and includes a housing, at least one battery cell positioned in the housing, and a terminal assembly configured to electrically connect the at least one battery cell to the circuit. The battery pack also includes at least one locking member, at least one actuator, and at least one biasing member. The at least one locking member is movable about a pivot point between a first position to engage the at least one recess and a second position. The at least one actuator is actuatable to move the at least one locking member from the first position to the second position. The at least one biasing member biases the at least one locking member to the first position.

Independent features and independent advantages of the invention will become apparent to those skilled in the art upon review of the detailed description and drawings.

### BRIEF DESCRIPTION OF THE DRAWINGS

FIG. 1 is a front perspective view of a battery.

FIG. 2 is a top rear perspective view of the battery pack shown in FIG. 1.

FIG. 3 is a bottom rear perspective view of the battery pack shown in FIG. 1.

FIG. 4 is a top view of the battery pack shown in FIG. 1.

FIG. 5 is a bottom view of the battery pack shown in FIG. 1.

FIG. 6 is a front view of the battery pack shown in FIG. 1.

FIG. 7 is a rear view of the battery pack shown in FIG. 1.

FIG. 8 is a right side view of the battery pack shown in FIG. 1.

FIG. 9 is a left side view of the battery pack shown in FIG. 1.

FIG. 10 is a bottom view of an alternate construction of a battery pack embodying aspects of the present invention.

FIG. 11A is a perspective view of an electrical device, such as a power tool, for use with the battery pack shown in FIG. 1.

FIG. 11B is a perspective view of the support portion of the power tool shown in FIG. 11A.

FIG. 12 is a perspective view of an electrical device, such as a battery charger, for use with the battery pack shown in FIG. 1.

FIG. 13 is a perspective view of a portion of the battery pack shown in FIG. 1 and illustrating the battery cells and the battery terminal assembly.

FIG. 14 is a top view of the battery cells and the battery terminal assembly shown in FIG. 13.

FIG. 15 is a bottom view of the battery cells and the battery terminal assembly shown in FIG. 13.

FIG. 16 is a front view of the battery cells and the battery terminal assembly shown in FIG. 13.

FIG. 17 is a rear view of the battery cells and the battery terminal assembly shown in FIG. 13.

FIG. 18 is a right side view of the battery cells and the battery terminal assembly shown in FIG. 13.

FIG. 19 is a left side view of the battery cells and the battery terminal assembly shown in FIG. 13.

FIG. 20 is a schematic diagram of components of a battery pack, such as the battery pack shown in FIG. 1.

FIG. 21 is another schematic diagram of components of a battery pack.

FIG. 22 is yet another schematic diagram of components of a battery pack.

FIG. 23 is still another schematic diagram of components of a battery pack.

FIG. 24 is a perspective view of a portion of the battery pack shown in FIG. 1 with portions removed.

FIG. 25 is a perspective view of a portion of the battery pack shown in FIG. 1 with portions removed.

FIG. 26 is a perspective view of a portion of the battery pack shown in FIG. 1 with portions removed.

FIG. 27 is a top view of the portion of the battery pack shown in FIG. 26.

FIG. 28 includes views of portions of the battery pack shown in FIG. 26.

FIG. 29 is an exploded perspective view of a portion of the battery pack shown in FIG. 1 with portions removed.

FIG. 30 is a rear perspective view of a portion of the battery pack shown in FIG. 1 with portions removed.

FIG. 31 is another rear perspective view of the portion of the battery pack shown in FIG. 30.

FIG. 32 is an exploded perspective view of a portion of the battery pack shown in FIG. 1 with portions removed.

FIG. 33 is a perspective view of the portion of the battery pack shown in FIG. 32.

FIG. 34 is an enlarged perspective view of a portion of the battery pack shown in FIG. 33.

FIG. 35 includes views of portions of the battery pack shown in FIG. 1 with portions removed.

FIG. 36 is a rear perspective view of an existing battery pack.

FIG. 37 is a front perspective view of the battery pack shown in FIG. 36.

FIG. 38 is a left side view of the battery pack shown in FIG. 36.

FIG. 39 is a perspective view of a portion of the battery pack shown in FIG. 36 and illustrating the battery cells and the battery terminal assembly.

FIG. 40 is a right side view of the battery cells and the battery terminal assembly shown in FIG. 39.

FIG. 41 is a front perspective view of another battery pack.

FIG. 42 is a right side view of the battery pack shown in FIG. 41.

FIG. 43 is a left side view of the battery pack shown in FIG. 41.

FIG. 44 is a top view of the battery pack shown in FIG. 41.

FIG. 45 is a bottom rear perspective view of the battery pack shown in FIG. 41.

FIG. 46 is a front view of the battery pack shown in FIG. 41.

FIG. 47 is a rear view of the battery pack shown in FIG. 41.

FIG. 48 is a front perspective view of a further battery pack.

FIG. 49 is a right side view of the battery pack shown in FIG. 48.

FIG. 50 is a left side view of the battery pack shown in FIG. 48.

FIG. 51 is a top view of the battery pack shown in FIG. 48.

FIG. 52 is a bottom rear perspective view of the battery pack shown in FIG. 48.

FIG. 53 is a front view of the battery pack shown in FIG. 48.

FIG. 54 is a rear view of the battery pack shown in FIG. 48.

FIG. 55 is a perspective view of a battery pack in use with a first electrical device, such as a power tool.

FIG. 56 is a perspective view of a battery pack in use with a second electrical device, such as a power tool.

FIG. 57 is a perspective view of a portion of a battery pack and illustrating the battery cells.

FIG. 58 is a perspective view of a portion of a battery pack and illustrating the battery cells, terminals, end caps and circuitry.

FIG. 59 is a rear perspective view of the portion of the battery pack shown in FIG. 58.

FIG. 60 is a right side view of the portion of the battery pack shown in FIG. 58.

FIG. 61 is a left side view of the portion of the battery pack shown in FIG. 58.

FIG. 62 is a front view of the portion of the battery pack shown in FIG. 58.

FIG. 63 is a rear view of the portion of the battery pack shown in FIG. 58.

FIG. 64 is a top view of the portion of the battery pack shown in FIG. 58.

FIG. 65 is a perspective view of a portion of a battery pack and illustrating the end caps.

FIG. 66 is a partial side perspective view of a portion of the housing of a battery pack.

FIG. 67 is a partial front perspective view of the portion of the housing shown in FIG. 66.

FIGS. 68-69 are still further schematic diagrams of components of a battery pack.

FIG. 70 is a partial cross-section of a battery cell.

FIG. 71 is a graph illustrating charging thresholds of Li-based battery packs.

FIG. 72 is a graph illustrating the performance of two battery packs during discharge.

FIG. 73 is a perspective view of a portion of a battery pack and illustrating the end caps.

FIG. 74 is a rear perspective view a battery pack.

FIG. 75 is a rear view of the battery pack shown in FIG. 74.

FIG. 76 is a perspective view of a portion of a battery pack and illustrating the battery cells.

FIG. 77 is a perspective view of a battery cell with portions removed.

FIG. 78 is a schematic view of a battery cell.

FIG. 79 is a schematic view of another battery cell.

FIG. 80 is a top view of a portion of a battery pack.

FIG. 81 is a front perspective view of a battery pack.

FIG. 82 is a rear perspective view of the battery pack shown in FIG. 81.

FIG. 83 is a front view of the battery pack shown in FIG. 81.

FIG. 84 is a rear view of the battery pack shown in FIG. 81.

FIG. 85 is a left view of the battery pack shown in FIG. 81.

FIG. 86 is a right view of the battery pack shown in FIG. 81.

FIG. 87 is a top view of the battery pack shown in FIG. 81.

FIG. 88 is a bottom view of the battery pack shown in FIG. 81.

FIG. 89 is an exploded view of a battery pack, such as the battery pack shown in FIG. 81.

FIG. 90 is a top view of a portion of the battery pack shown in FIG. 89 and illustrating the locking members.

FIG. 91 is another top view of a portion of the battery pack shown in FIG. 89 and illustrating the locking members.

Before any independent embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items.

### DETAILED DESCRIPTION

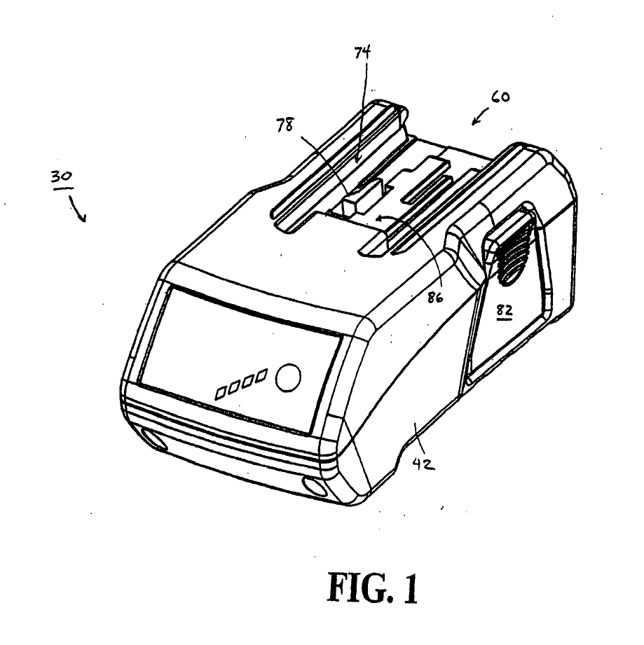

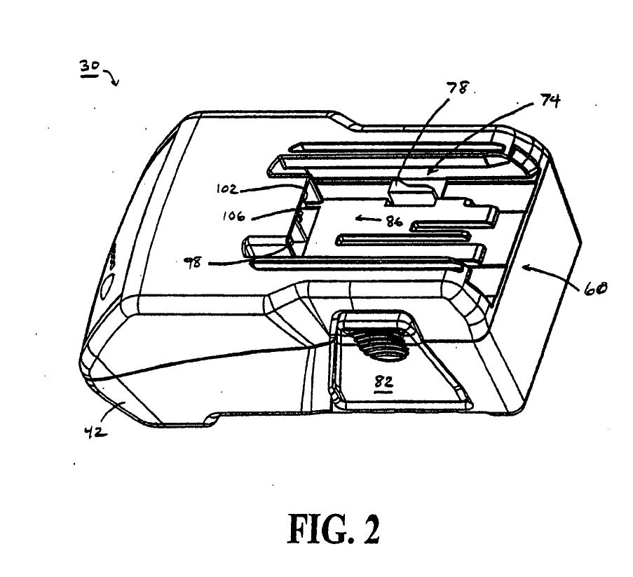

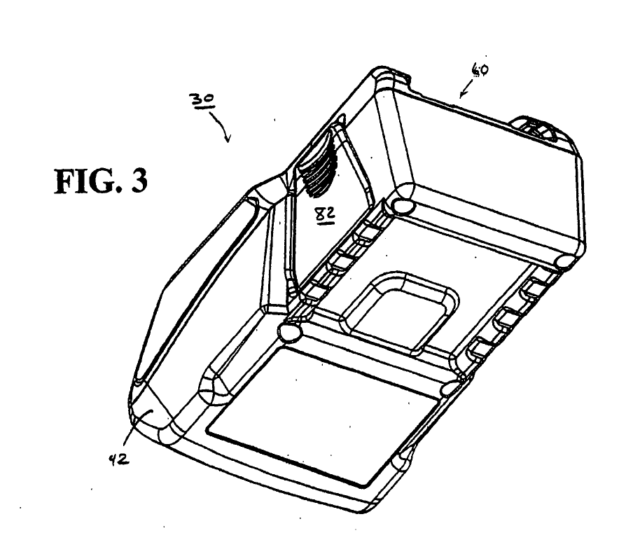

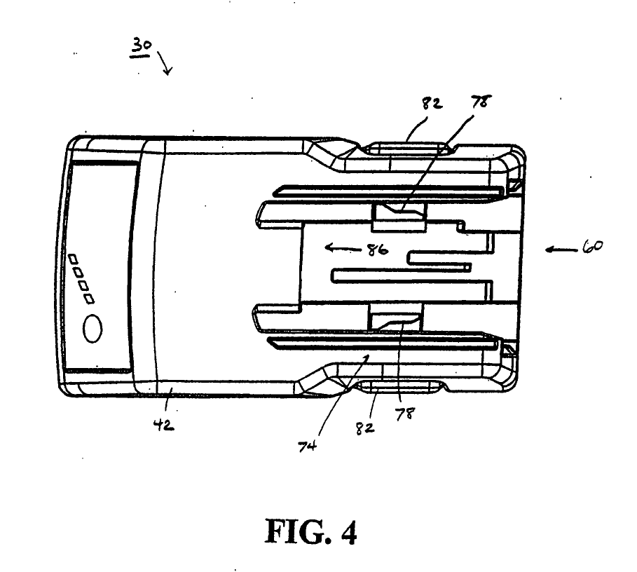

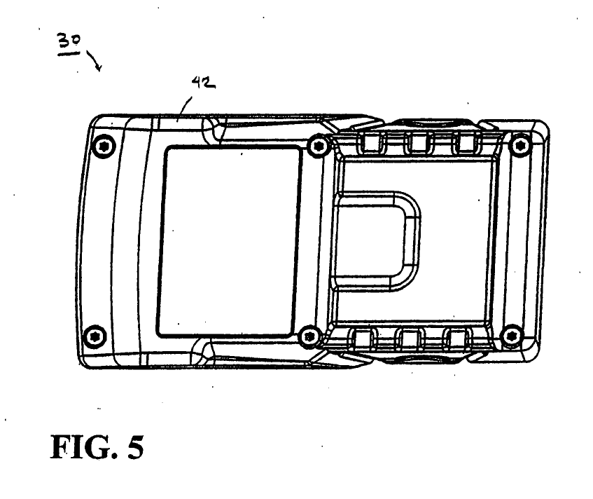

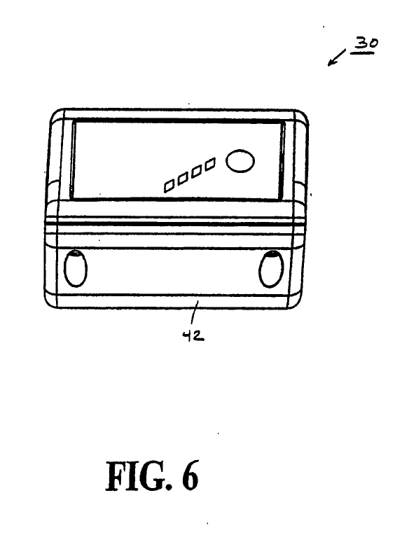

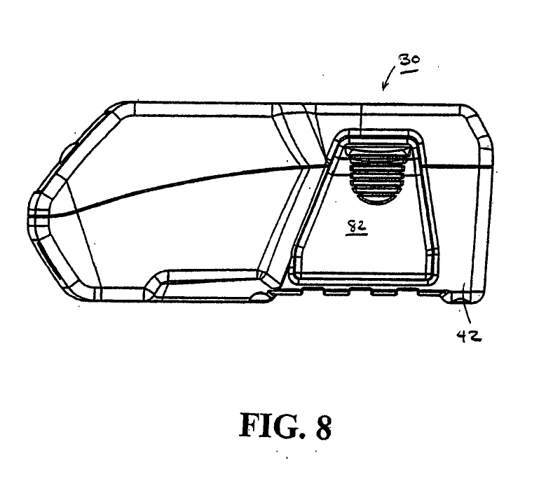

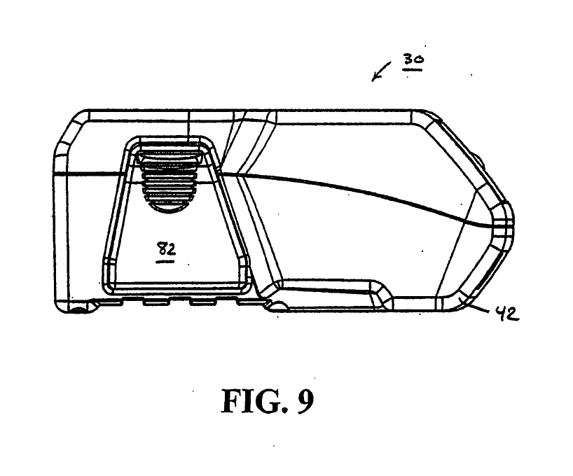

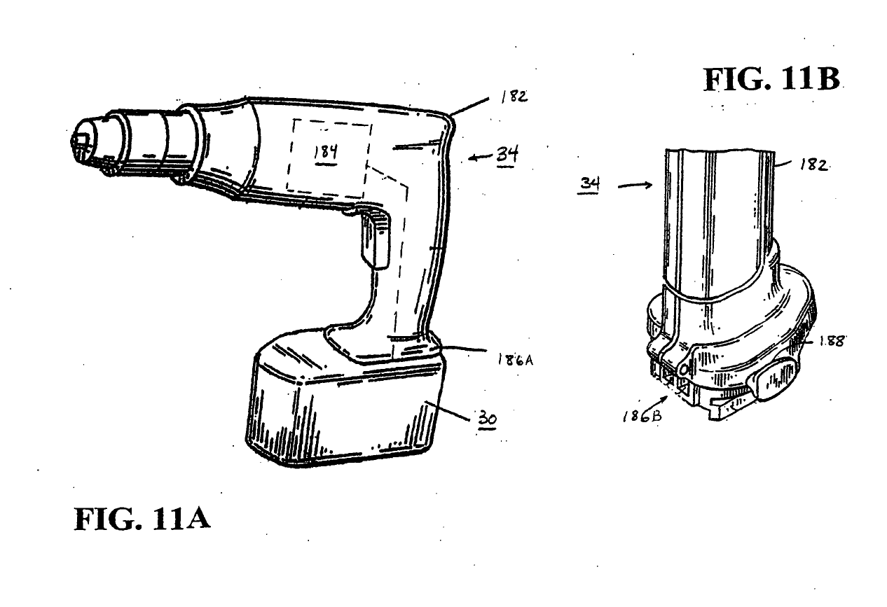

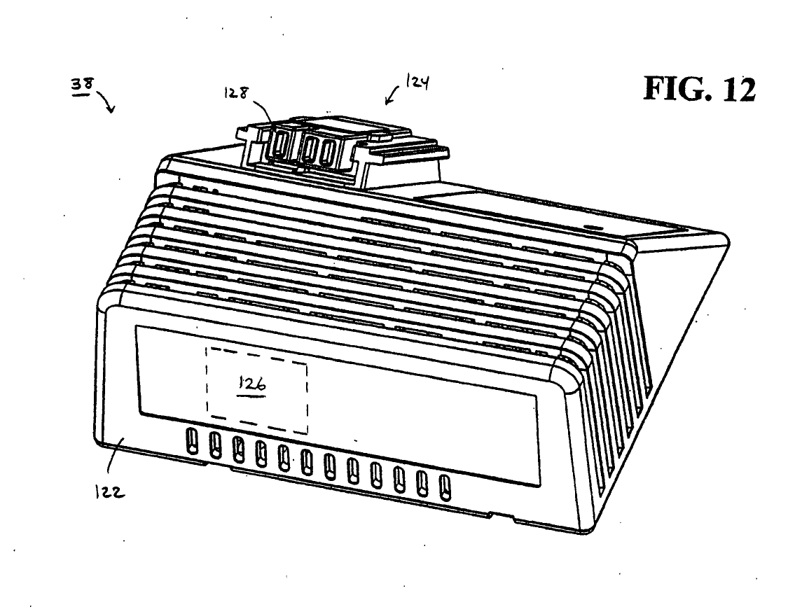

A battery pack 30 embodying aspects of the invention is illustrated in FIGS. 1-9. The battery pack 30 can be connectable to electrical equipment, such as, for example, a cordless power tool 34 (shown in FIG. 11A) to selectively power the power tool 34. The battery pack 30 can be removable from the power tool 34 and can be rechargeable by a battery charger 38 (shown in FIG. 12).

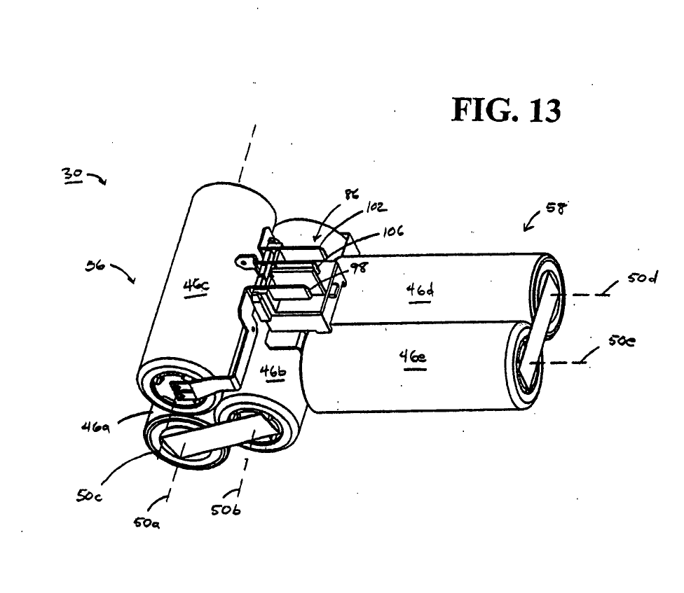

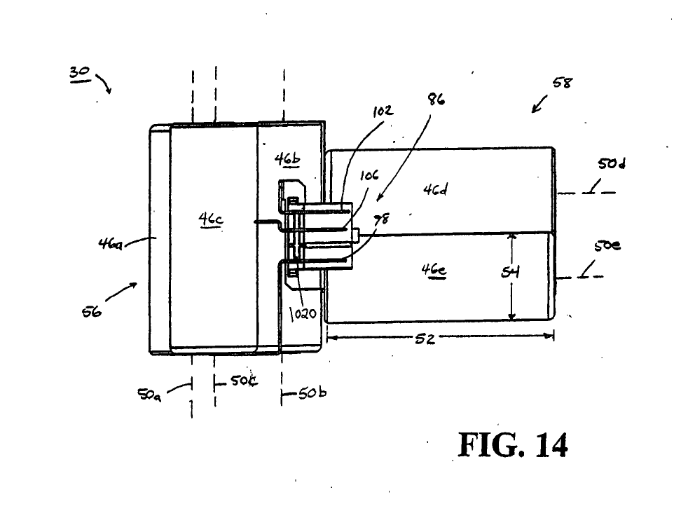

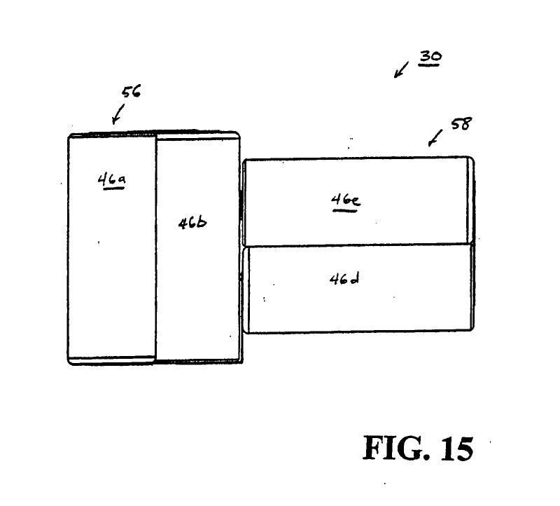

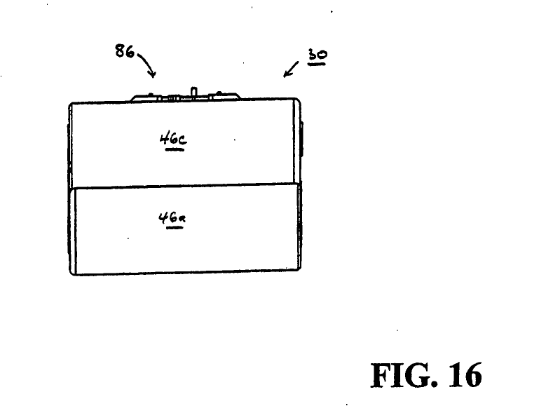

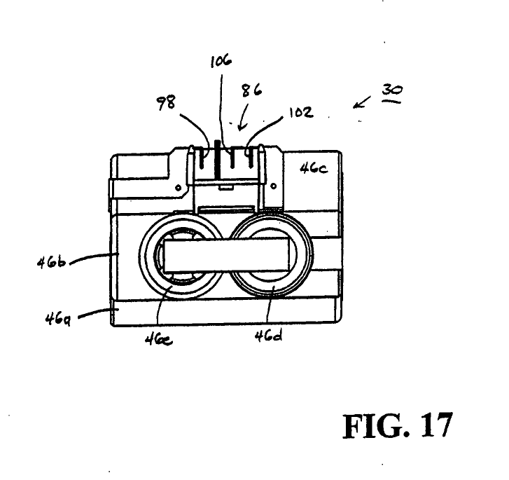

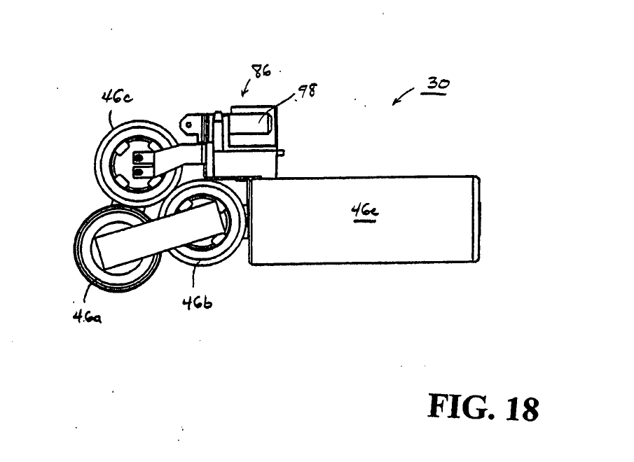

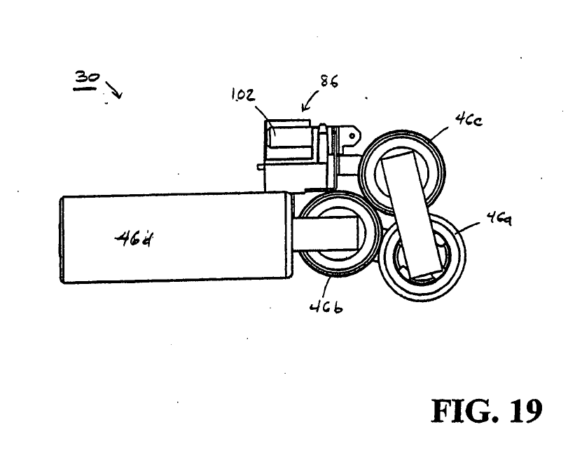

As shown in FIGS. 1-9, the battery pack 30 includes a housing 42 and at least one rechargeable battery cell 46 (shown in FIGS. 13-19) supported by the housing 42. In the illustrated construction, the battery pack 30 can be a 21V battery pack including five approximately 4.2V battery cells 46a, 46b, 46c, 46d and 46e connected in series. In another construction, the battery pack 30 can be a 28V battery pack including seven approximately 4.2V battery cells 46. In other constructions, the battery pack 30 includes at least six battery cells 46 to have a nominal voltage of approximately 28V. In further constructions (not shown), the battery pack 30 may have another nominal battery voltage, such as, for example, 9.6V, 12V, 14.4V, 24V, 28V, 40V, etc., to power the electrical equipment and be charged by the battery charger 38.

In some constructions, the battery pack 30 may include five to ten battery cells 46. In other constructions, the battery pack 30 may include six to eight battery cells 46. In further constructions, the battery pack 20 may include two to ten battery cells 46. In some constructions, the battery cells 46 can have a nominal voltage, such as, for example, approximately 3.6V, approximately 4.0V, approximately 4.2V, and approximately 4.3V. It should be understood that, in other constructions (not shown), the battery cells 46 may have a different nominal cell voltage and/or may be connected in another configuration, such as, for example, in parallel or in a parallel/series combination.

The battery cells 46 may be any rechargeable battery cell chemistry type, such as, for example, nickel cadmium (NiCd), nickel-metal hydride (NiMH), Lithium (Li), Lithium-ion (Li-ion), other Lithium-based chemistry, other rechargeable battery cell chemistry, etc. The lithium-ion (Li-ion) battery cells can have a chemistry of Lithium-Cobalt (Li—Co), Lithium-Manganese (Li—Mn) Spinel, Li—Mn Nickel, another lithium metal chemistry, or the like.

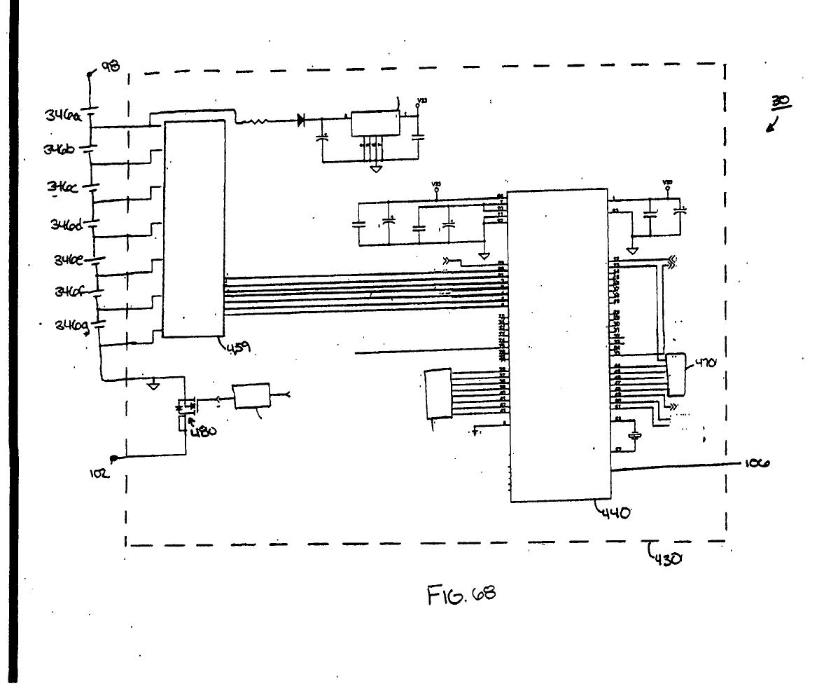

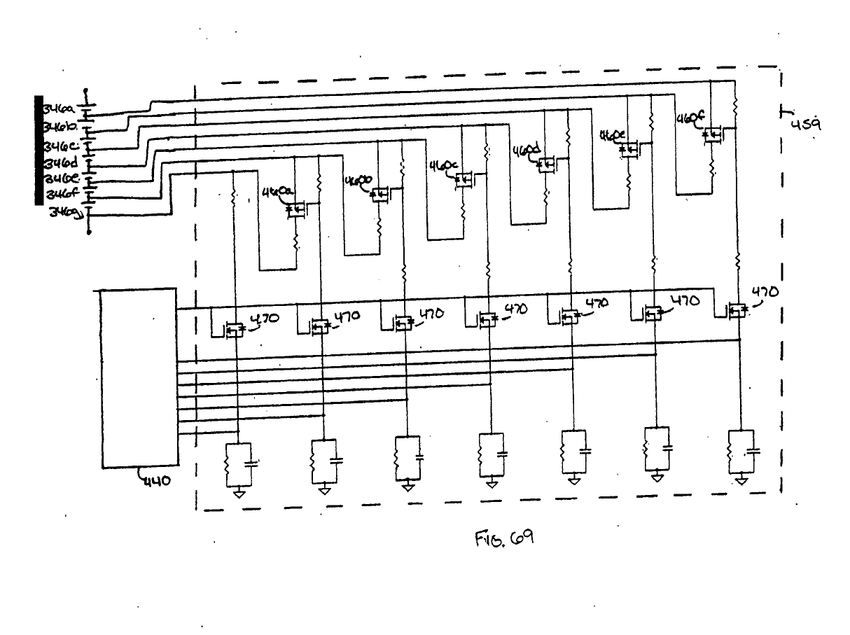

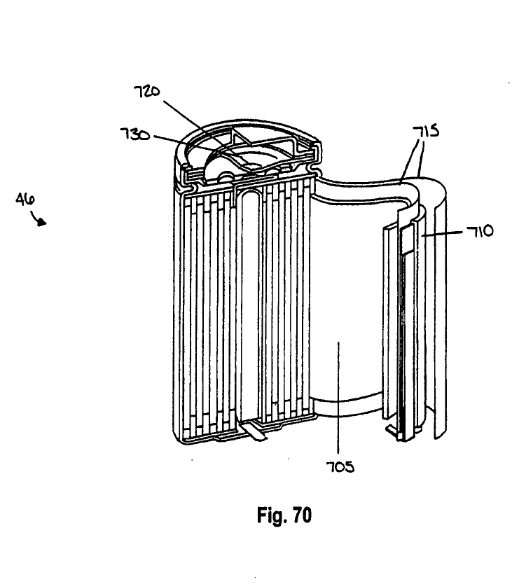

As shown in FIG. 70, the battery cell 46 includes cathode material 705 and anode material 710. The cathode material 705 and anode material 710 are separated by a separator 715. In one construction, the cathode material 705 includes Li—Mn Spinel, the anode material 710 includes lithium graphite, and the separator 715 includes polyethylene polypropylene laminate. In this construction, the Li—Mn Spinel battery cell 46 is typically more stable than a Li—Co battery cell, which can allow for a larger cell size. A battery cell 46 of this construction can operate at high current discharge rates and does not build large internal resistance during cycle life.

In some constructions, such as the illustrated construction of FIG. 70, the cell 46 includes one or more safety mechanisms. For example, in one construction, the separator 715 can include a plastic porous separator material that melts between approximately 120° C. and approximately 150° C. When the separator 715 begins to melt, the pores close. This causes the cell 46 to be disabled.

Also, the cell 46 can include a disconnect device 720, in some constructions. In these constructions, the disconnect device 720 is pressure activated. If the cell 46 is overcharged, a voltage triggered polymer (not shown) within the cell 46 creates gas and pressure. With enough pressure, the disconnect device 720 will permanently open the electrical connection to the outside, which disables the cell 46.

Also in some constructions, the cell 46 can include a rupture vent 730. In the instance of large internal pressure buildup (under thermal or mechanical abuse situations), the vent 730 can safely release the gas pressure, such that the cell 46 does not explode.

In one construction, the working temperature range for the Li-ion battery cells 46 is approximately −20° C. to +75° C. As compared to battery cells of other chemistries, the Li-ion battery cells 46 have a wider working temperature range. For example, battery cells of NiCd construction do not deliver power as well as Li-ion cells 46 at higher temperatures, and battery cells of NiMH construction do not deliver power as well as Li-ion cells 46 at lower temperatures. Also, Li-ion battery cells 46 can be lightweight and compact without sacrificing performance due to high energy densities. Gravimetric energy density for Li-ion battery cells 46 is approximately 150 Wh/kg, which can be compared to existing NiCd battery cells. In some constructions, the gravimetric energy density for Li-ion battery cells 46 is approximately 2.5 times as high as existing NiCd battery cells. Volumetric energy density for Li-ion battery cells 46 is approximately 390 Wh/L, which can also be compared to existing NiCd battery cells. In some constructions, the volumetric energy density for Li-ion battery cells 46 is approximately 2.0 times as high as existing NiCd battery cells.

In some constructions and in some aspects, battery cells 46 having a Li-ion based chemistry, such as Li—Co or Li—Mn Spinel, can have higher operating voltages, lower self discharge and also eliminate the use of environmentally hard elements in the construction of the cells 46, when compared to existing Nickel based cells, such as NiCd and NiMH. In one construction, a Li-ion battery cell has a nominal voltage of approximately 4.0V versus NiCd and NiMH cells having a nominal voltage of approximately 1.2V.

Also, in this construction, a typical self discharge rate for a Li-ion battery cell 46 is approximately 2% to approximately 5% per month, whereas a typical self discharge rate for a NiCd battery cell is approximately 15% to approximately 20%.

Further, in this construction, the Li-ion battery cells 46 help to eliminate the environmentally hazardous heavy metals, such as lead, nickel, and cadmium, which are present in other battery types. The inclusion of these environmentally hazardous metals in other battery types requires special recycling methods. In the illustrated constructions, the Li-ion battery cells 46 do not contain environmentally hazardous materials. Rather, in these constructions, the Li-ion cells 46 include graphite powder, Li—Mn spinel, carbonate solvents, lithium hexafluorophosphate, copper, aluminum and polyvinylidene fluoride (“PVDF”). The cells 46 also include steel, nickel, and an inert material for the can. In these constructions, a Li-ion battery cell 46 does not require any special recycling.

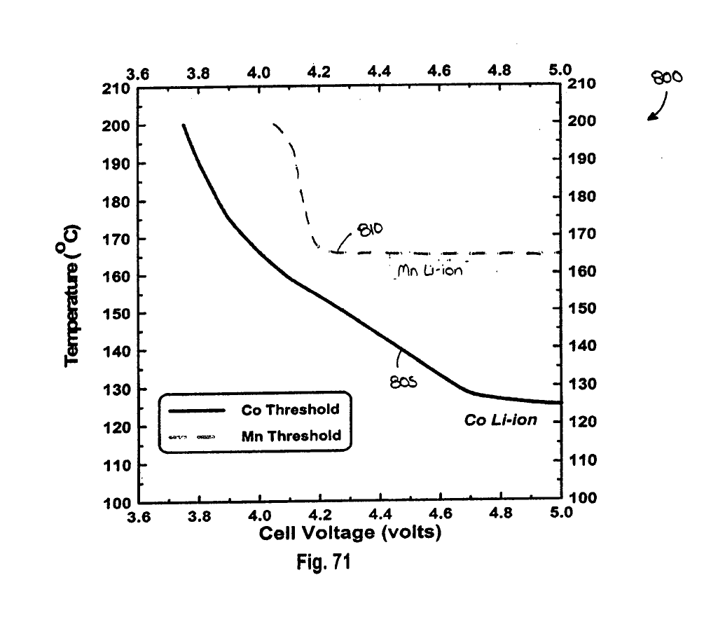

In some constructions, the battery cells 46 can have a chemistry of Li—Co. In these constructions, the battery cells 46 can be monitored in order to protect the battery cells 46 from being overdischarged or overcharged, both of which can damage the cells 46 and affect the stability of the cells 46. In some constructions, Li—Co cells 46 may require tighter control during charging and discharging operation than Li—Mn Spinel cells. For example, in some constructions, the Li—Co cells 46 are monitored more closely during charging to prevent overcharging. In these constructions, overcharging of a Li—Co cell 46 may cause lithium metal to plate on the anode of the cell 46, may cause lithium metal to become a powerful reducing agent during plating, may cause the cathode material to become unstable and a strong oxidizing agent, and may cause excessive heating. Also, lithium metal and the destabilization of the cathode material can make the Li—Co cell 46 more sensitive to thermal runaway. The graph 800 shown in FIG. 71 helps illustrate the tighter control needed for charging Li—Co cells compared to Li—Mn cells. The curve 805 illustrates the charging threshold for Li—Co cells based on cell voltage and temperature. The curve 810 illustrates the charging threshold for Li—Mn cells based on cell voltage and temperature. Any point falling above the respective thresholds 805 and 810 represents thermal runaway. Cells having a Li—Mn based chemistry can have an increased voltage capacity and still maintain a high temperature tolerance during charging. Cells having a Li—Co based chemistry should be charged at a lower temperature threshold if the cells increase voltage capacity.

Similarly, for battery cells 46 having a chemistry of Li—Mn, the cells 46 can also be monitored in order to protect the battery cells 46 from being overdischarged or overcharged. Examples of systems and methods to monitor battery cells are described in more detail in U.S. patent application Ser. No. 10/720,027, filed Nov. 20, 2003 and Ser. No. 11/138,070, filed on May 24, 2005, the contents of all of which are hereby incorporated by reference.

As shown in FIGS. 13-20, in the battery pack 30, each battery cell 46a-46e can be generally cylindrical and can extend along a cell axis 50a-50e parallel to the cylindrical outer cell wall. Also, in the battery pack 30, each battery cell 46 can have a cell length 52 which is more than two times and almost three times the cell diameter 54. In the illustrated construction and in some aspects, each battery cell 46 can have a diameter of about twenty-six millimeters (26 mm) and a length of at least about sixty millimeters (60 mm). In some constructions, each battery cell 46 can have a length of about sixty-five millimeters (65 mm). In some constructions, each battery cell 46 can have a length of about seventy millimeters (70 mm). Another example of a battery cell is shown and described in U.S. Pat. No. 6,489,060, issued Dec. 3, 2002, the content of which is hereby incorporated by reference.

The battery cells 46 are arranged in a first set 56 of battery cells 46a, 46b and 46c and a second set 58 of battery cells 46d and 46e. In the first set 56, the cell axes 50a, 50b and 50c are parallel to one another. In the second set 58, the cell axes 50d and 50e are parallel to each other. However, the sets 56 and 58 are arranged so that the battery cells 46a, 46b and 46c are non-parallel to the battery cells 46d and 46e. In the illustrated construction, for example, the battery cells 46a, 46b and 46c can be normal to the battery cells 46d and 46e.

The battery cells 46 are arranged to reduce the heat transfer between the battery cells 46 and to improve the collection and removal of heat from the battery cells 46. In this manner, the battery cells 46 may be able to be maintained in an appropriate temperature operating range for longer durations of use. The battery cells 46 are also arranged to provide an efficient use of space and to maintain a relatively small pack size.

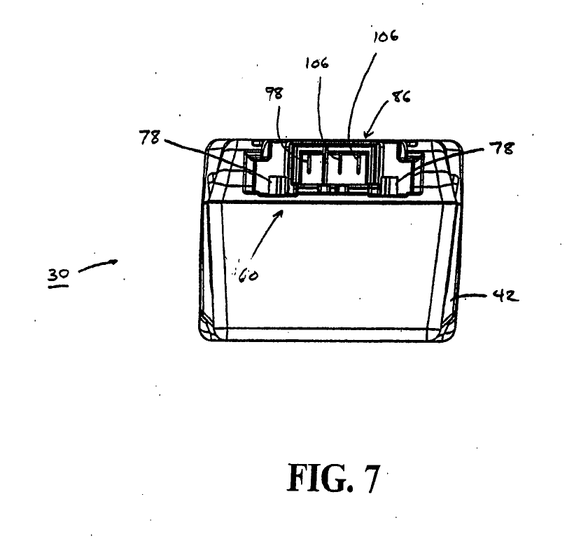

As shown in FIGS. 1-4 and 7, the housing 42 can provide a support portion 60 for supporting the battery pack 30 on an electrical device, such as the power tool 34 or the battery charger 38. In the illustrated construction, the support portion 60 provides a C-shaped cross section (see FIG. 7) which is connectable to a complementary T-shaped cross section support portion on the electrical device.

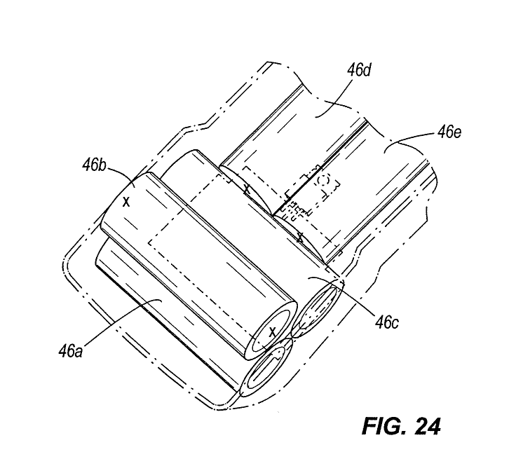

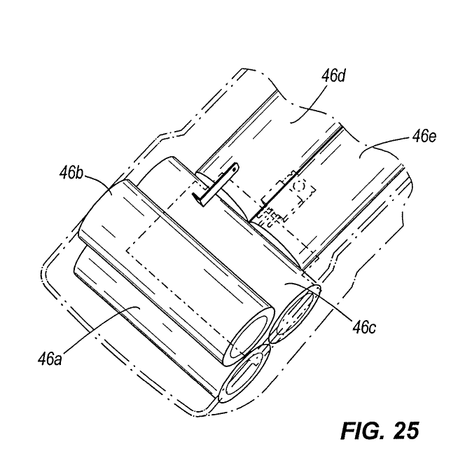

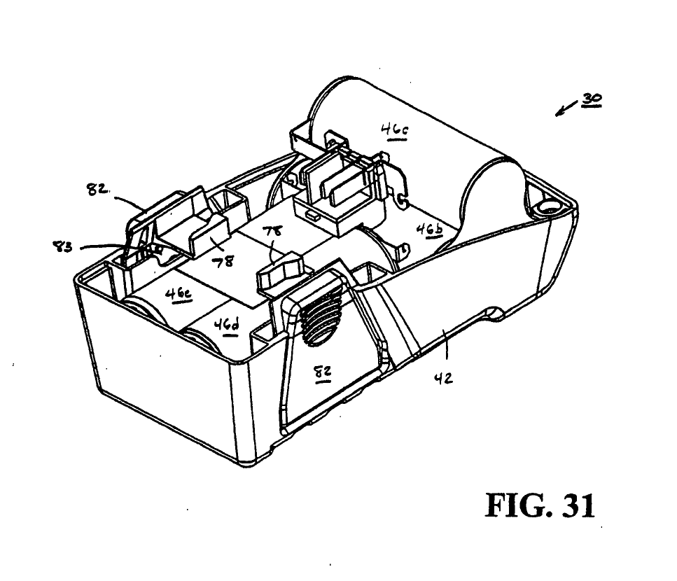

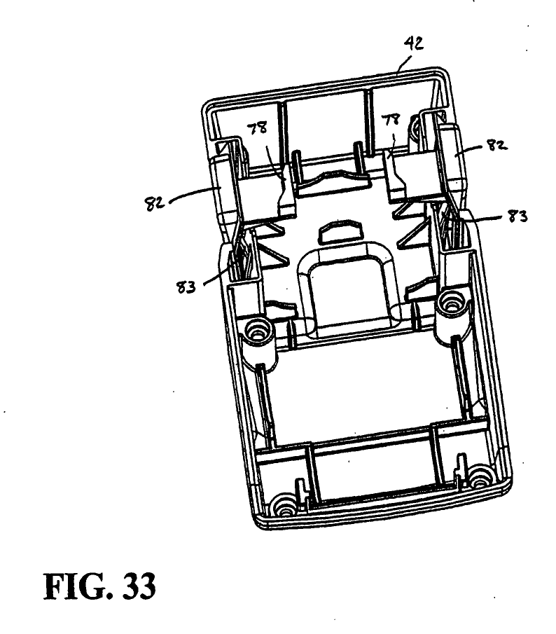

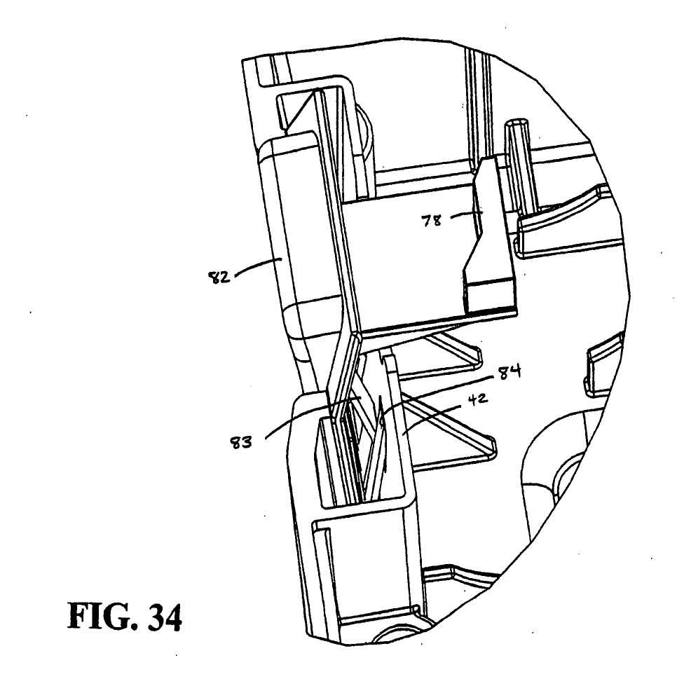

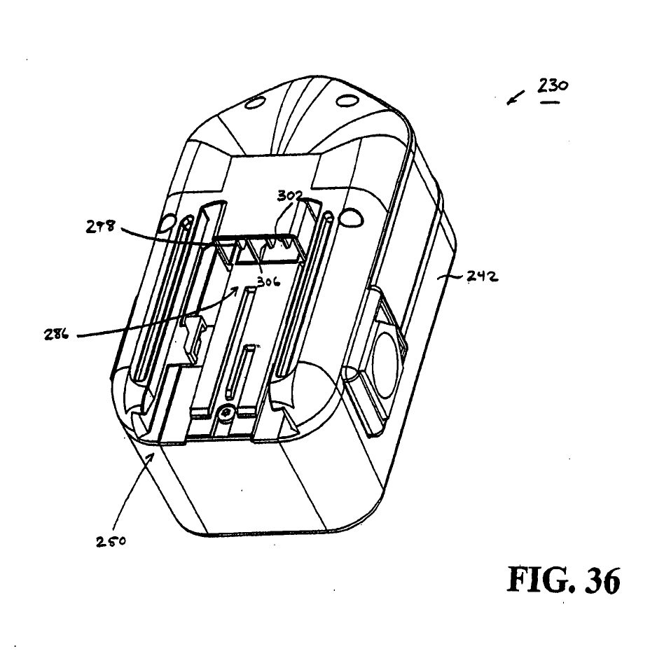

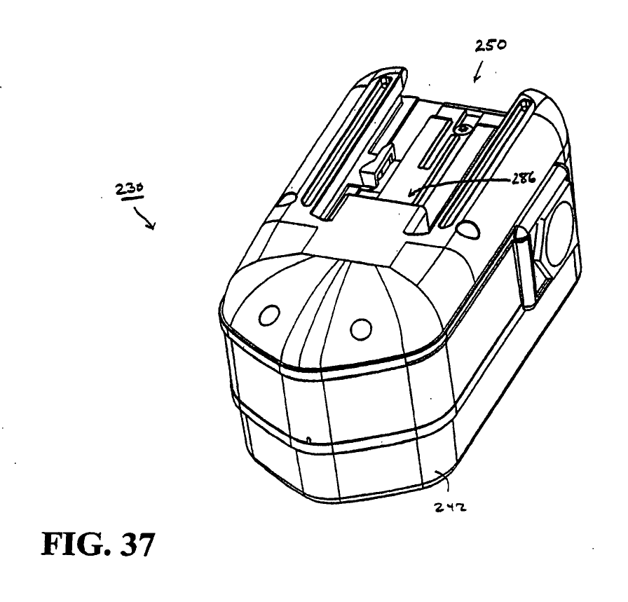

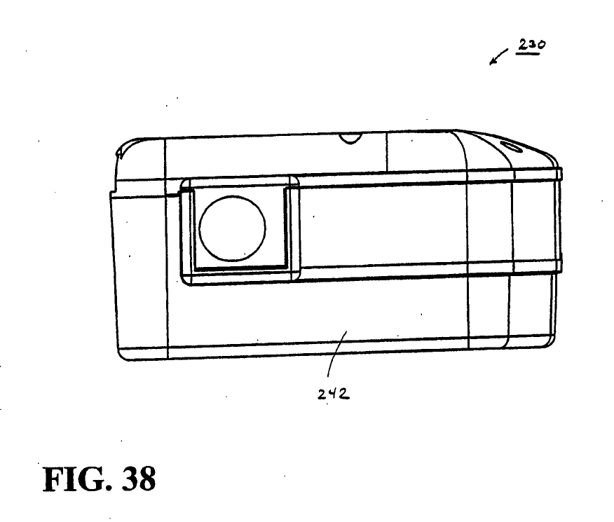

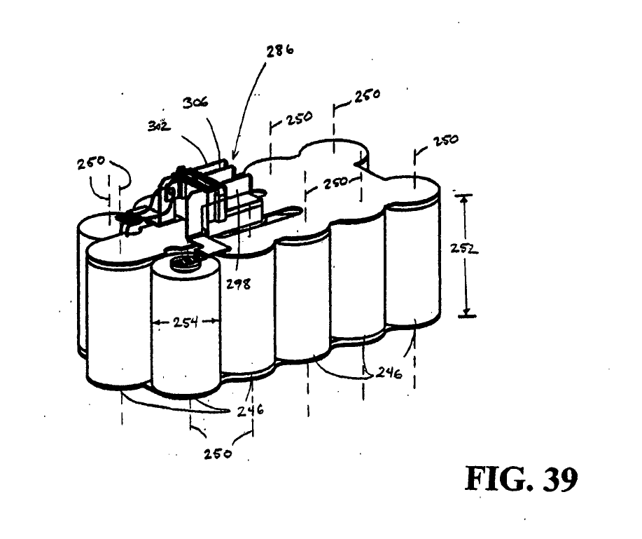

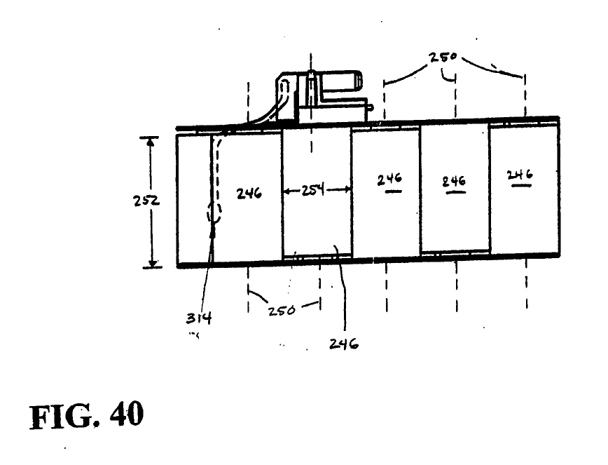

The battery pack 30 also can include (see FIGS. 1-4, 8-9, 21, 24-25 and 30-38) a locking assembly 74 operable to lock the battery pack 30 to an electrical device, such as, for example, to the power tool 34 and/or to a battery charger. The locking assembly 34 includes locking members 78 which are movable between a locked position, in which the locking members 78 engage a corresponding locking member on the electrical device to lock the battery pack 30 to the electrical device, and an unlocked position. The locking assembly 74 also includes actuators 82 for moving the locking members 78 between the locked position and the unlocked position. The actuators 82 have a large surface for engagement by an operator to provide improved ease of unlocking the locking assembly 74. Also, the actuators 82 are supported to reduce the gripping force required to unlock the locking assembly 74.

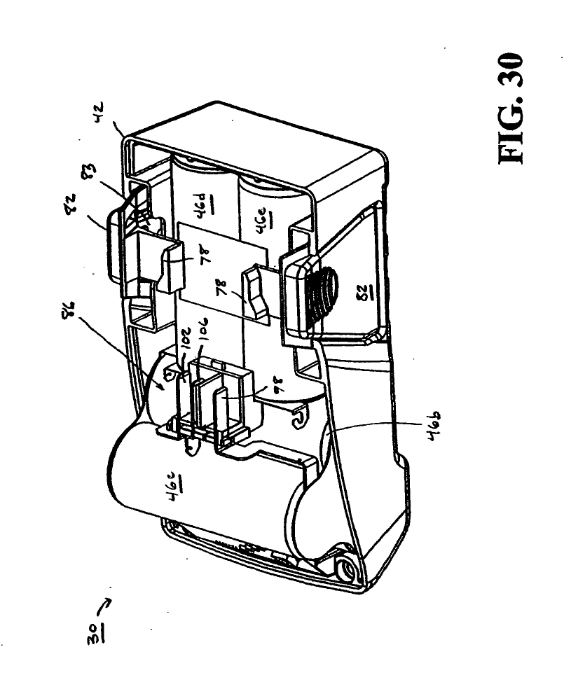

As shown in FIGS. 30-38, biasing members 83 bias the locking members 78 toward the locked position. In the illustrated construction, each biasing member 83 is a leaf spring positioned between the actuator 82 and the housing 42 to bias the locking member 78 to the locked position.

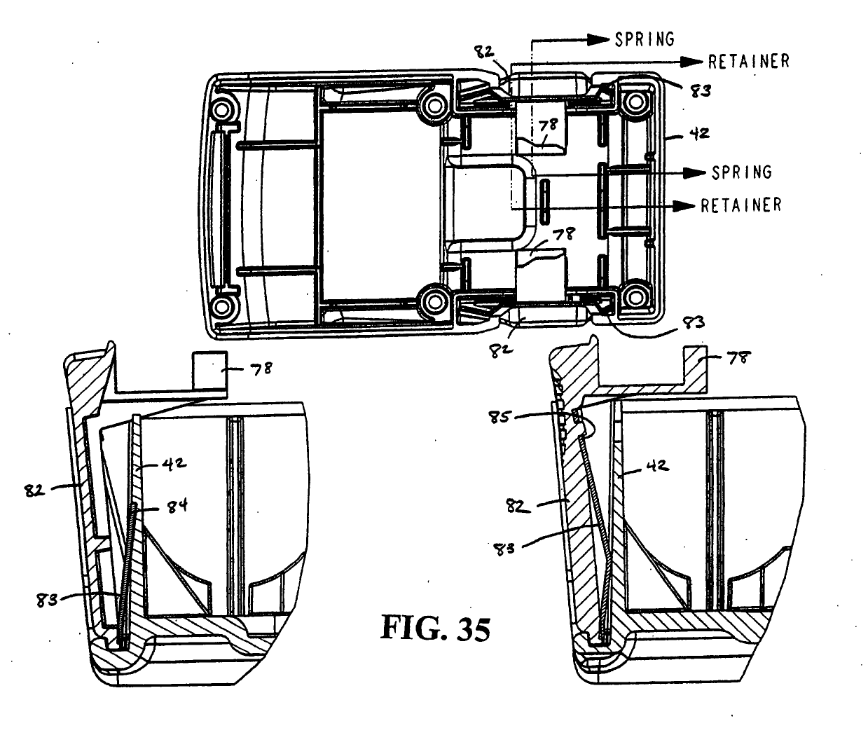

Each biasing member 83 is fixed between the actuator 82 and the housing 42 and operates to retain the actuator 82 (and the locking member 78) in a position and to limit unwanted movement of the actuator 82 (and the locking member 78) relative to the housing 42. Specifically, the biasing member 83 limits movement of the actuator 82 (and of the locking member 78) in a direction perpendicular to the direction of movement between the locked position and the unlocked position (i.e., upwardly in the cross-sectional views of FIG. 35) to prevent the actuator 82 and/or the locking member 78 from binding on the housing 42 or from being prevented to move in the desired manner to operate the locking assembly 74.

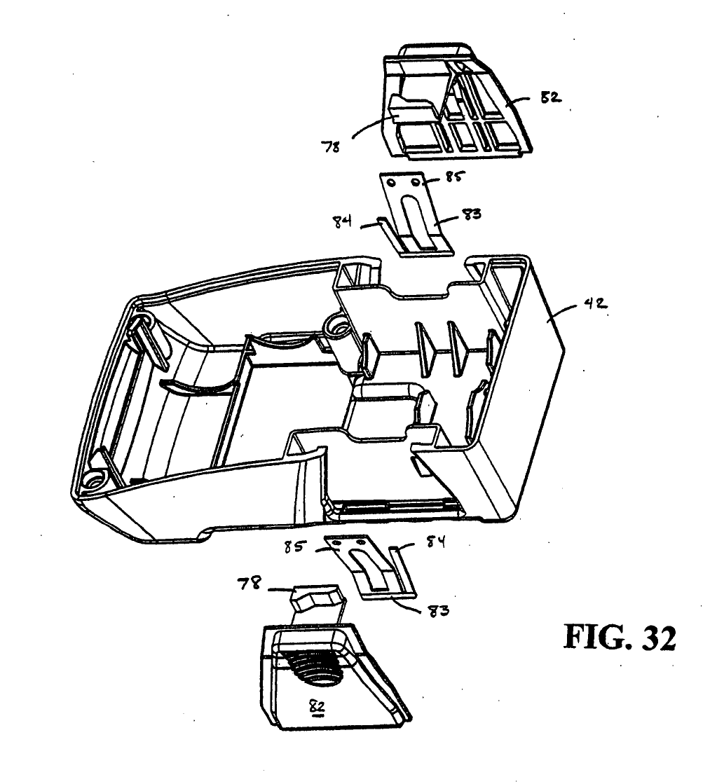

As shown in FIGS. 32 and 35, the biasing member 83 includes a housing leg 84 engaging the housing 42 to force the biasing member 83 downwardly (in the left cross-sectional view of FIG. 35). The biasing member 83 also includes (see the right cross-sectional view of FIG. 35) an actuator leg 85 engaging the actuator 83 to draw and retain the actuator 82 (and the locking member 78) in the correct downward position (in the cross-sectional views of FIG. 35) during operation of the locking assembly 74 and of the battery pack 30.

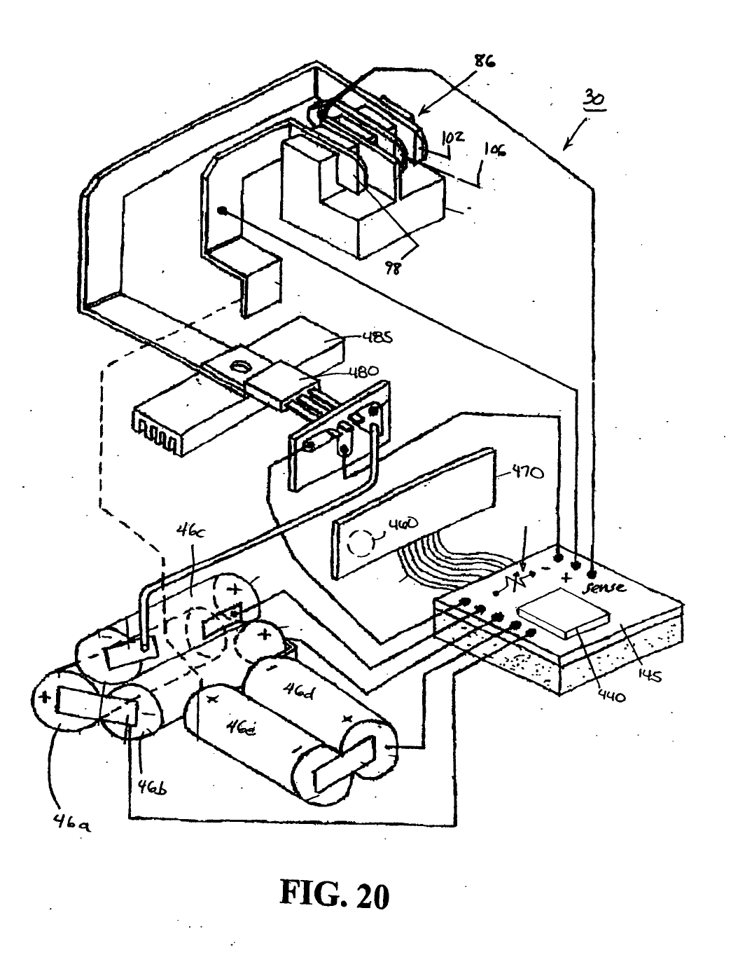

The battery pack 30 includes (see FIGS. 1-5, 7, 13-14 and 17-20) a terminal assembly 86 operable to electrically connect the battery cells 46 to a circuit in the electrical device. The terminal assembly 86 includes (see FIGS. 1-3) a positive battery terminal 98, a ground terminal 102, and a sense terminal 106. As schematically illustrated in FIG. 20, the terminals 98 and 102 are connected to the opposite ends of the cell or series of cells 46.

The sense terminal 106 can be connected to one or more electrical components, such as an identification component (i.e., a resistor) to communicate the identification of a characteristic of the battery pack 30, such as, for example, the chemistry of the battery cells 46, the nominal voltage of the battery pack 30, etc., or a temperature-sensing device or thermistor to communicate the temperature of the battery pack 30 and/or of the battery cell(s) 46. It should be understood that, in other constructions (not shown), the electrical components may be other types of electrical components and may communicate other characteristics or information about the battery pack 30 and/or of the battery cell(s) 46. It should also be understood that “communication” and “communicate”, as used with respect to the electrical components, may also encompass the electrical components having or being in a condition or state which is sensed by a sensor or device capable of determining the condition or state of the electrical components.

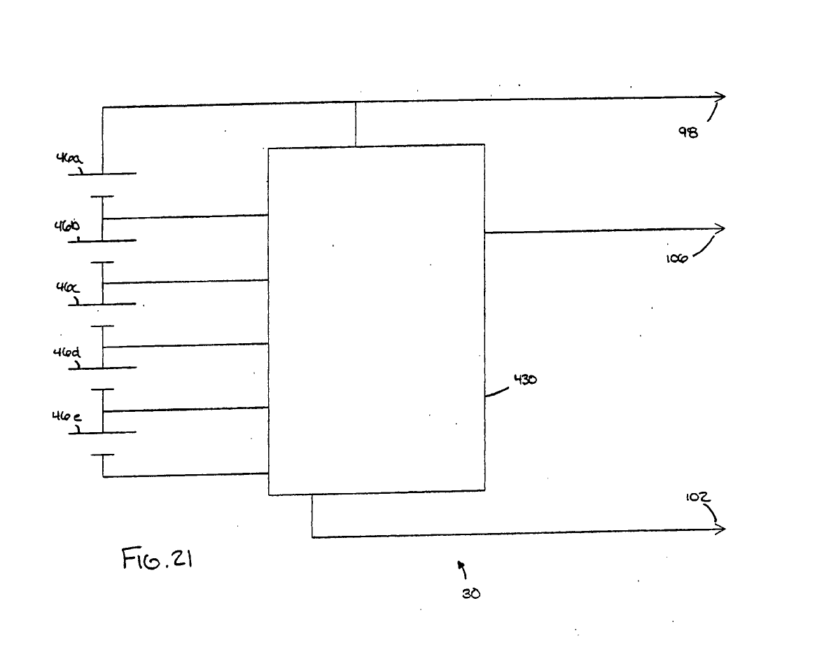

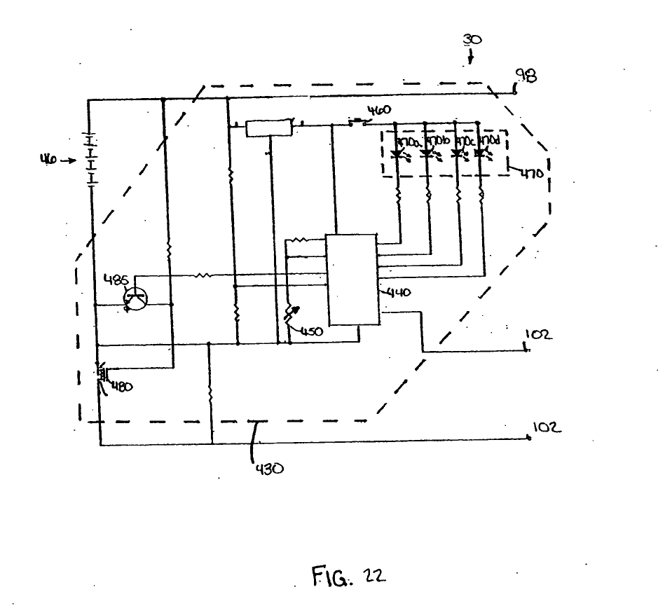

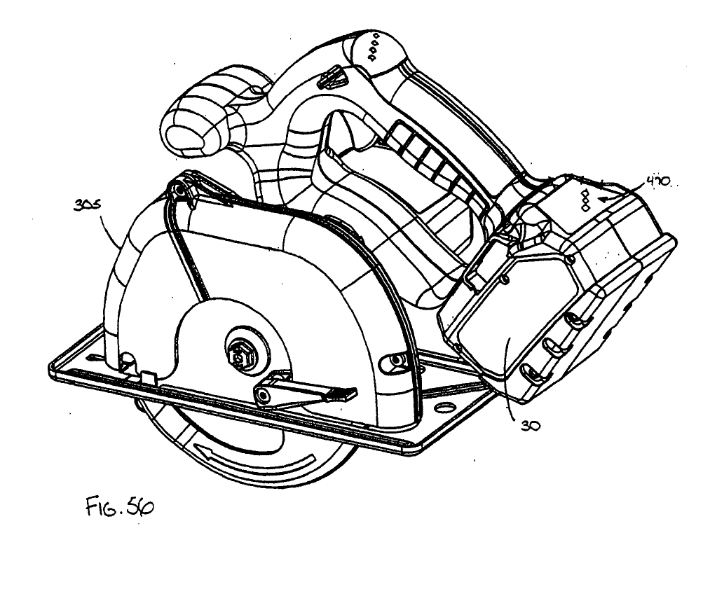

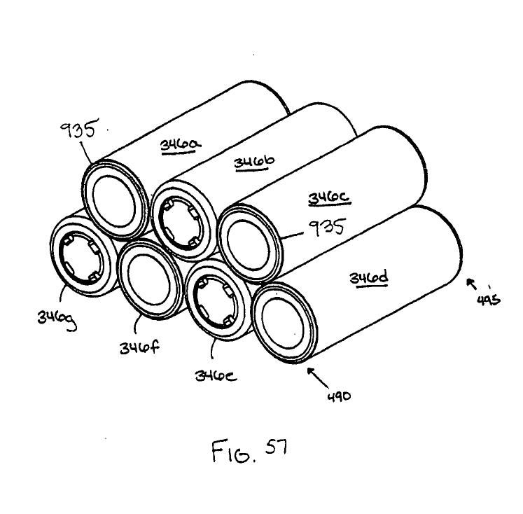

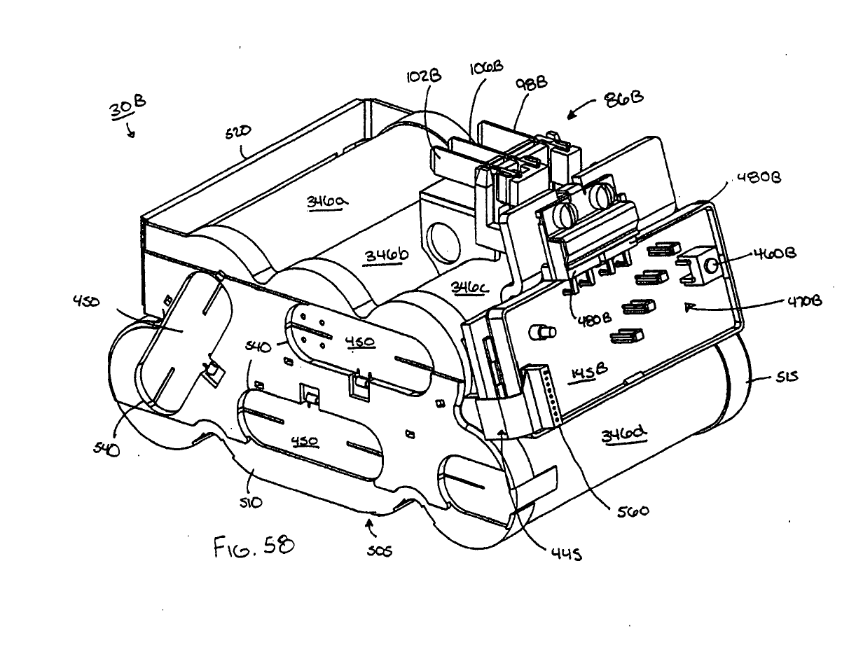

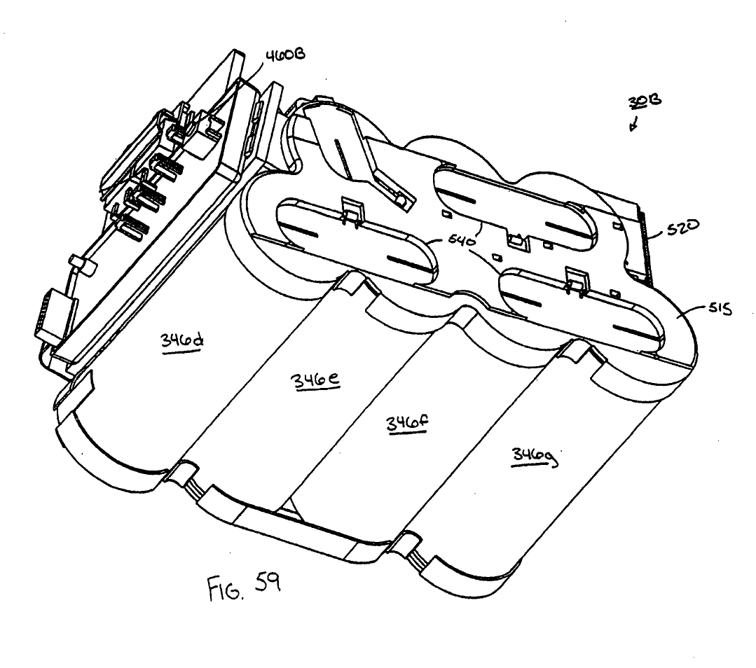

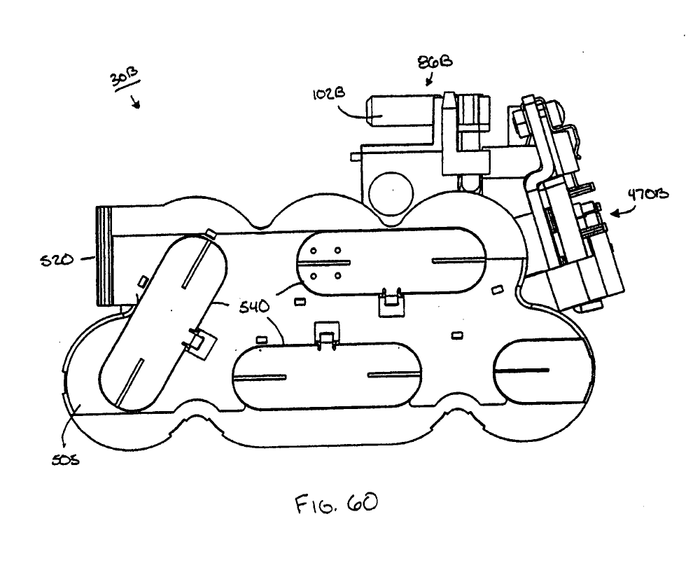

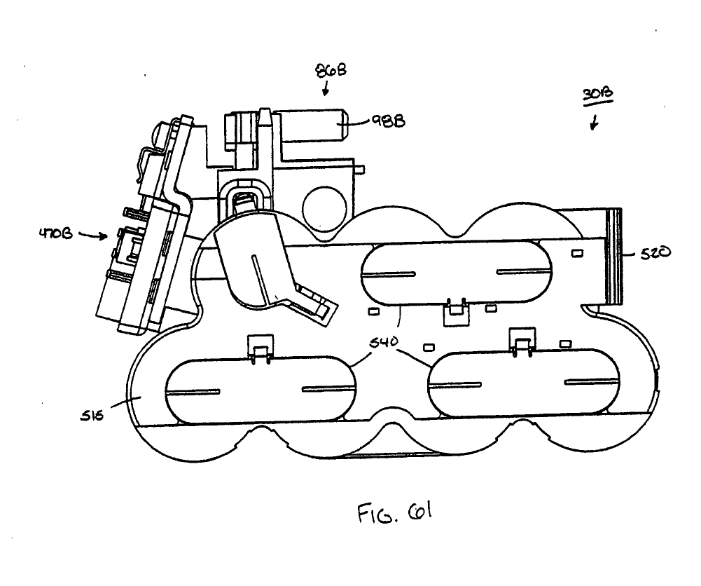

In some constructions and in some aspects, the sense terminal 106 can be connected to a circuit 430, as shown in FIGS. 21-23 and 68-69. Referring to FIGS. 21 and 22, the circuit 430 can be electrically connected to one or more battery cells 46, and can be electrically connected to one or more battery terminals of the terminal assembly 86. In some constructions, the circuit 430 can include components to enhance the performance of the battery pack 30. In some constructions, the circuit 430 can include components to monitor battery characteristics, to provide voltage detection, to store battery characteristics, to display battery characteristics, to inform a user of certain battery characteristics, to suspend current within the battery 50, to detect temperature of the battery pack 30, battery cells 46, and the like, to transfer heat from and/or within the battery 30, and to provide balancing methods when an imbalance is detected within one or more battery cells 46. In some constructions and in some aspects, the circuit 430 includes a voltage detection circuit, a boosting circuit, a state of charge indicator, and the like. In some constructions, the circuit 430 can be coupled to a print circuit board (PCB) 145 (see FIG. 20). In other constructions, the circuit 430 can be coupled to a flexible circuit 445, as discussed below with reference to FIGS. 58-65. In some constructions, the flexible circuit 445 can wrap around one or more cells 46 or wrap around the interior of the housing 42.

In some constructions, a circuit can also include a microprocessor 440. The microprocessor 440 can monitor various battery pack parameters (e.g., battery pack present state of charge, battery cell present state of charge, battery pack temperature, battery cell temperature, and the like), can store various battery pack parameters and characteristics (including battery pack nominal voltage, chemistry, and the like, in addition to the parameters), can control various electrical components within the circuit, and can conduct communication with other electrical devices, such as, for example, a power tool, a battery charger, and the like. In some constructions, the microprocessor 440 can monitor each battery cell's present state of charge and can identify when an imbalance occurs (e.g., the present state of charge for a battery cell exceeds the average cell state of charge by a certain amount or drops below the average cell state of charge by a certain amount).

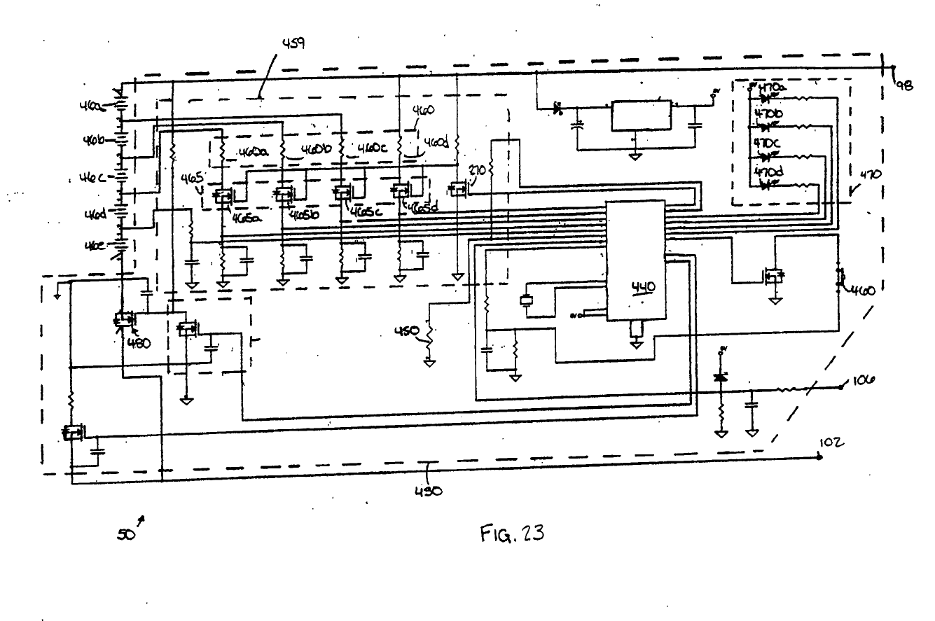

Referring to FIG. 23, in some constructions and in some aspects, the circuit 430 can include a voltage detection circuit 459. In some constructions, the voltage detection circuit 459 can include a plurality of resistors 460 forming resistor divider networks. As shown in the illustrated construction, the plurality of resistors 460 can include resistors 460a-d. The plurality of resistors 460 can be electrically connected to one or more battery cells 46a-e and to a plurality of transistors 465. In the illustrated construction, the plurality of transistors 465 can include transistors 465a-d. In some constructions, the number of resistors included in the plurality of resistors 460 can equal the number of transistors included in the plurality of transistors 465.

In some constructions, voltage characteristics of the battery pack 30 and/or of the battery cells 46 can be read by the microprocessor 440 through the plurality of resistors 460 when the microprocessor 440 is in the active mode. In some constructions, the microprocessor 440 can initiate a voltage-read event by turning off transistor(s) 470 (i.e., transistor 470 becomes non-conducting). When the transistor(s) 470 is non-conducting, the transistors 465a-d become conducting and voltage measurements regarding the battery pack 30 and/or battery cells 46 can be made by the microprocessor 440. Including the plurality of transistors 465 in the battery pack 30 can reduce the parasitic current draw from the battery pack 30, because the transistors 465 are only conducting periodically.

In some constructions, the microprocessor 440 can monitor the voltage of each battery cell 46 and balance the cell 46 if an imbalance occurs. As previously discussed, the battery pack 30 can include the plurality of resistors 460 for providing voltage measurements of the battery cells 46. The plurality of resistors 460 are arranged such that the microprocessor 440 can measure the voltage of each battery cell 46a-e approximately at the same time. In some constructions, the microprocessor 440 detects an imbalance within the battery pack 30 when one or more cells 46 reach approximately 1 V.

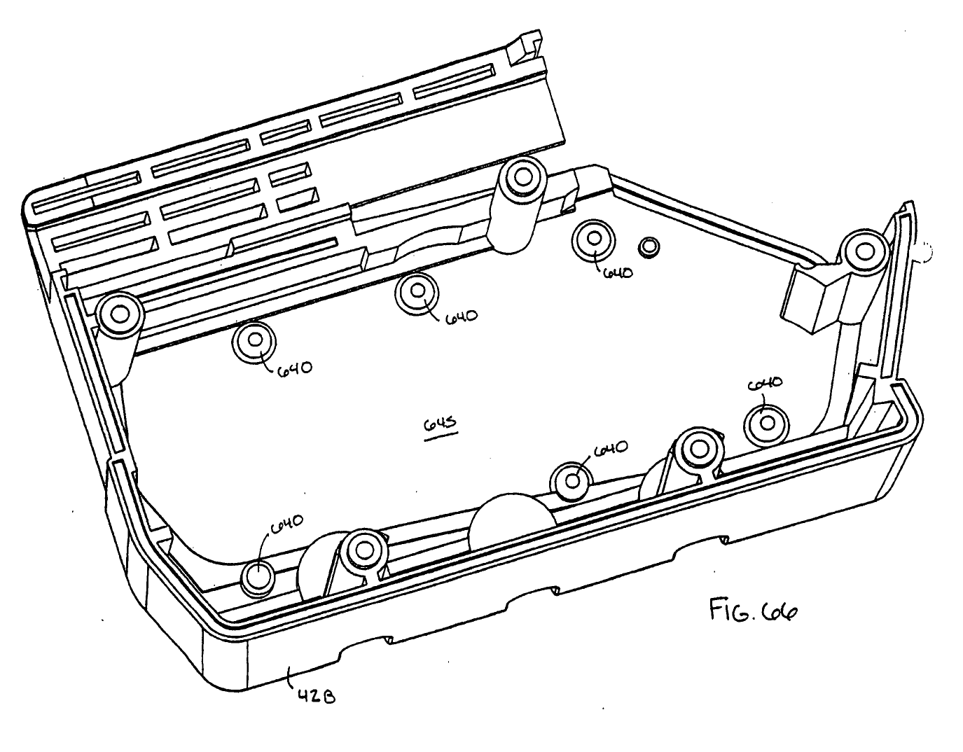

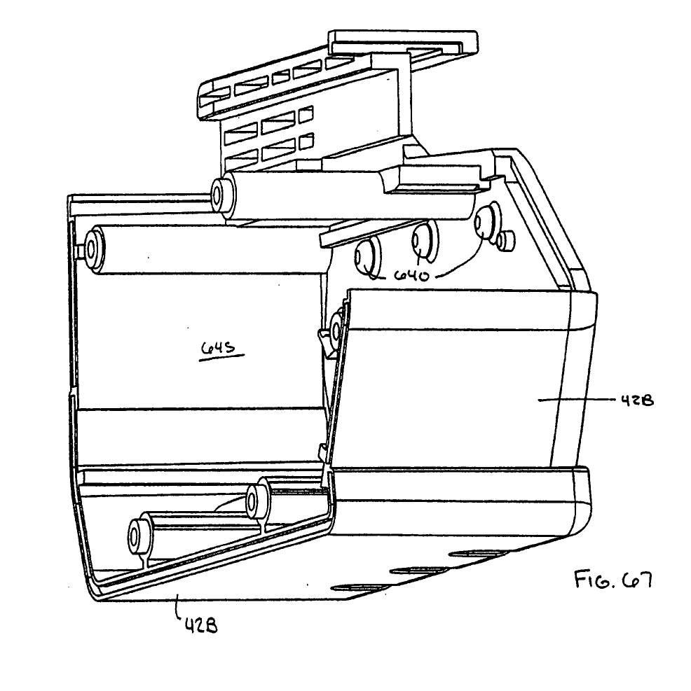

Referring to FIGS. 68 and 69, in some constructions and in some aspects, the battery pack 30 may re-balance the cells 46 when an imbalance has been detected via a balancing circuit 459. In some constructions, the battery pack 30 re-balances the battery cells 46 when the battery pack 30 is in a discharging operation or act or when the battery pack 30 is not providing a discharge current or receiving a charge current. In some constructions, the balancing circuit 459 can include the plurality of resistors 460 and the plurality of transistors 465. In some constructions, the microprocessor 440 disables the battery 30 (e.g. interrupts battery operation, prevents battery operation, etc.) via the switch 180 when a balanced ratio R between cells 46 is no longer included within an acceptable range. After the battery pack 30 is disabled, the microprocessor 440 determines which cell(s) 46 is imbalanced (the “low voltage cell”).

In some constructions, the microprocessor 440 activates or turns on the respective transistors, such as, for example, transistors 465a-d, that are electrically connected to those cells 46 that are not low in present state of charge (i.e., cells having a higher present state of charge than the low voltage cell). The microprocessor 440 begins a controlled discharge of the high present state of charge cells 46. For example, the microprocessor 440 will control the small discharge current that will flow from the balanced cells 46 through the respective transistors. The microprocessor 440 will continue to make voltage measurements of the cells 46 throughout the controlled discharging process. The microprocessor 440 will end the controlled discharge process when the present state of charge of the higher state of charge cells 46 is reduced to be approximately equal to the previously low voltage cell.

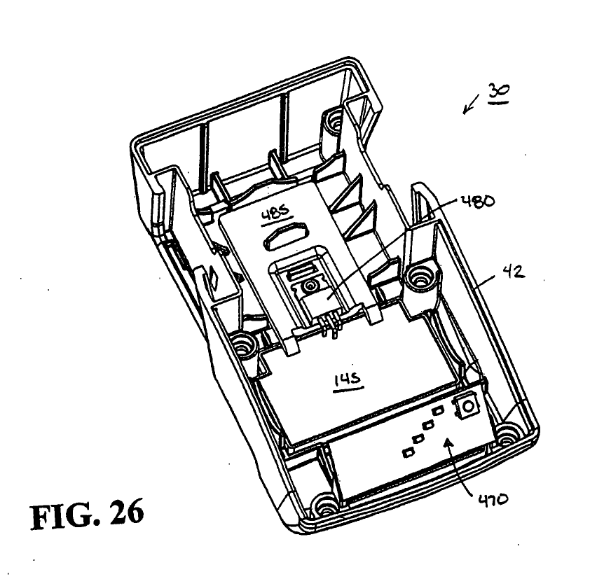

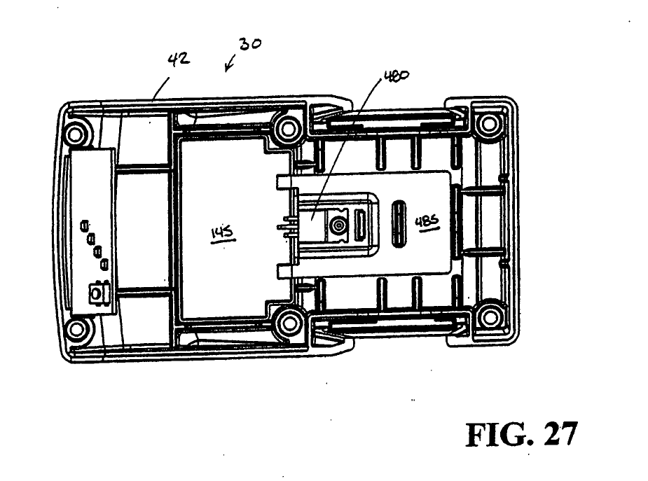

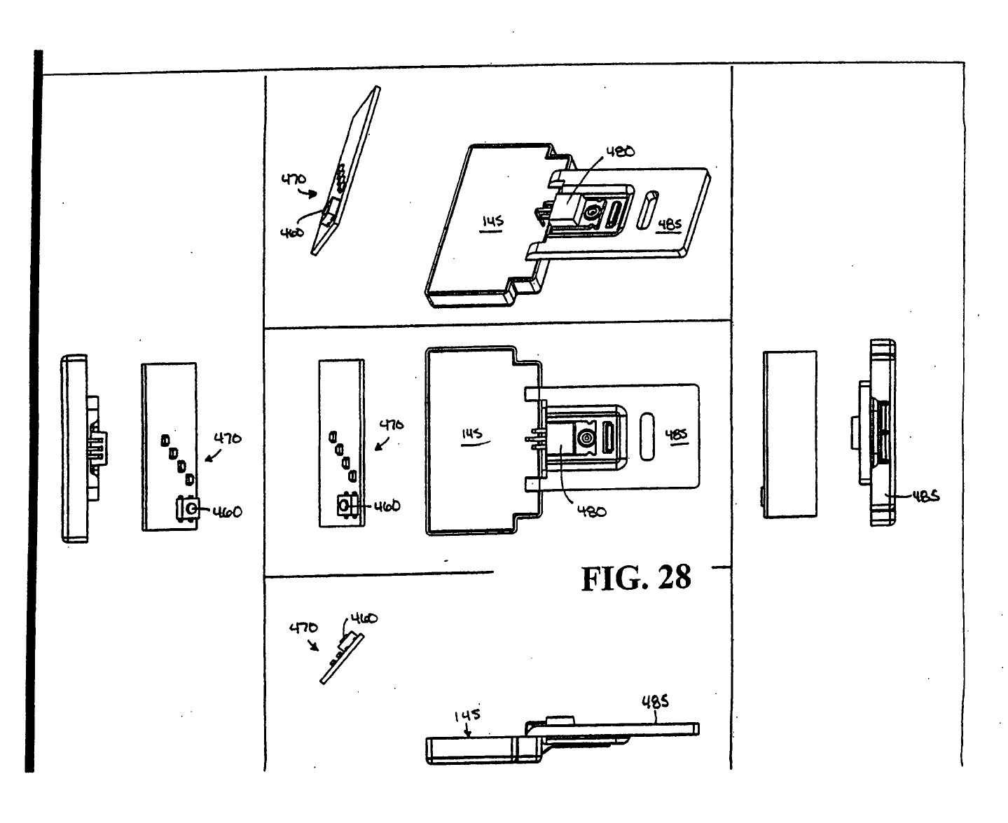

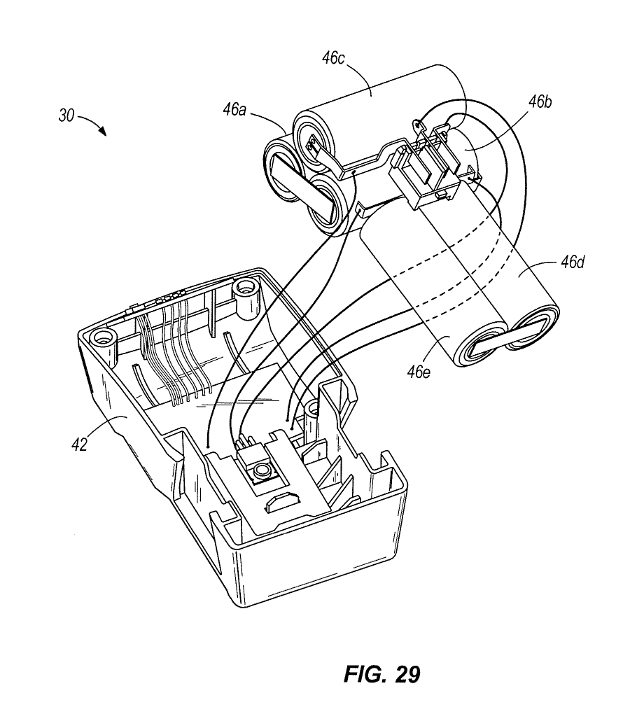

Components of the circuit 430 and of the battery pack 30, such as, for example, a FET 480, a heat sink 485, a thermistor 450, a fuel gauge 170 (including one or more light-emitting diodes 470a-d), a push-button 460 for activating the fuel gauge 470, a microprocessor 440, and the like, are illustrated in more detail in FIGS. 20-29. For some constructions and for some aspects, these and other additional independent features and structure of the battery pack 30 and other operations of the battery pack 30 are described in more detail in U.S. patent application Ser. No. 10/720,027, filed Nov. 20, 2003, and Ser. No. 11/138,070, filed May 24, 2005.

As shown in FIG. 12, the battery charger 38 is connectable to the battery pack 30 and is operable to charge the battery pack 30. The battery charger 38 includes a charger housing 122 providing a support portion 124, on which the battery pack 30 is supported, and a charging circuit 126 (schematically illustrated in FIG. 12) is supported by the housing 122 and connectable to a power source (not shown). The charging circuit 126 is connectable by a charger terminal assembly 128 to the terminal assembly 86 of the battery pack 30 and is operable to transfer power to the battery pack 30 to charge the battery cell(s) 46.

In some constructions and in some aspects, the charging circuit 126 operates to charge the battery pack 30 in a manner similar to that described in U.S. Pat. No. 6,456,035, issued Sep. 24, 2002, and U.S. Pat. No. 6,222,343 on Apr. 24, 2001, which are hereby incorporated by reference.

For some constructions and for some aspects, additional independent features, structure and operation of the battery charger 38 are described in more detail in U.S. patent application Ser. No. 10/720,027, filed Nov. 20, 2003, Ser. No. 10/719,680, filed Nov. 20, 2003, Ser. No. 11/138,070, filed on May 24, 2005, and Ser. No. 11/139,020, filed on May 24, 2005.

The battery pack 30 is connectable to electrical equipment, such as, for example, the power tool 34 (shown in FIG. 11A). The power tool 34 includes a housing 182 supporting an electric motor 184 (schematically illustrated) which is electrically connected to the battery pack 30 by (see FIG. 11B) a power tool terminal assembly 186B so that the motor 184 is selectively powered by the battery pack 30. The housing 182 provides (see FIG. 11A) a support portion 186A on which the battery pack 30 is supported. The support portion 186A has a generally T-shaped cross section which is complementary to the C-shaped cross section of the support portion 60 of the battery pack 30. The support portion 186A also defines locking recesses 188 (one shown) in which the locking members 78 are engageable to lock the battery pack 30 to the power tool 34.

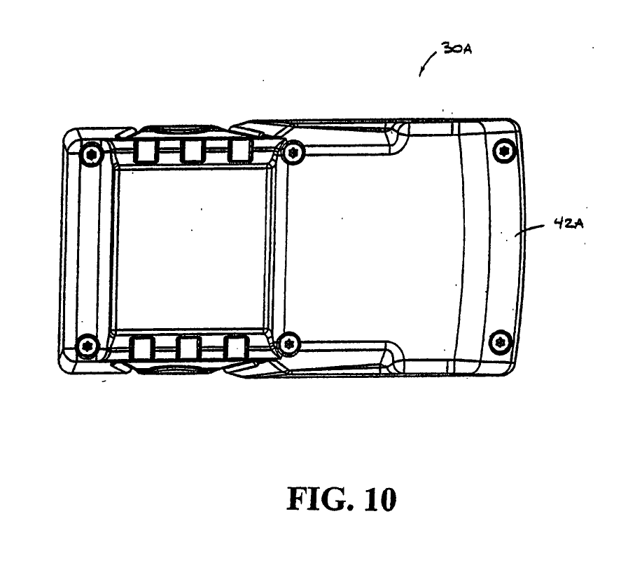

An alternative construction of a battery pack 30A embodying aspects of the invention is illustrated in FIG. 10. Common elements are identified by the same reference number “A”.

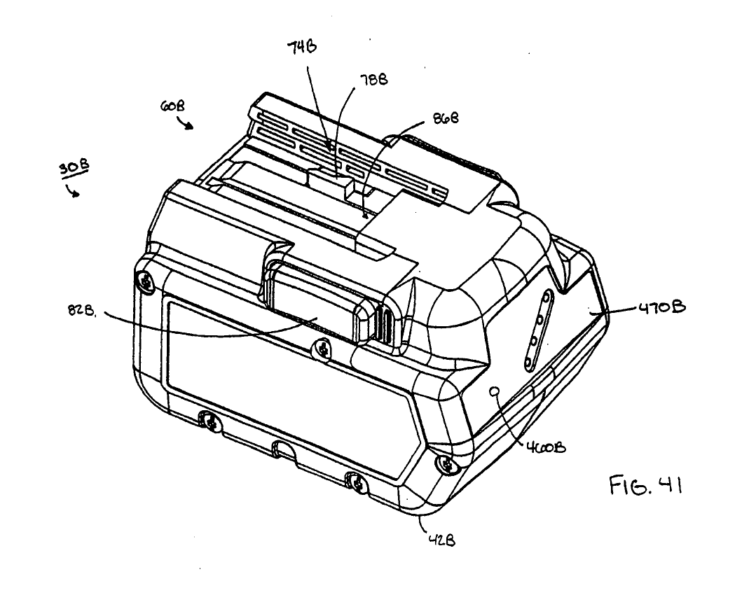

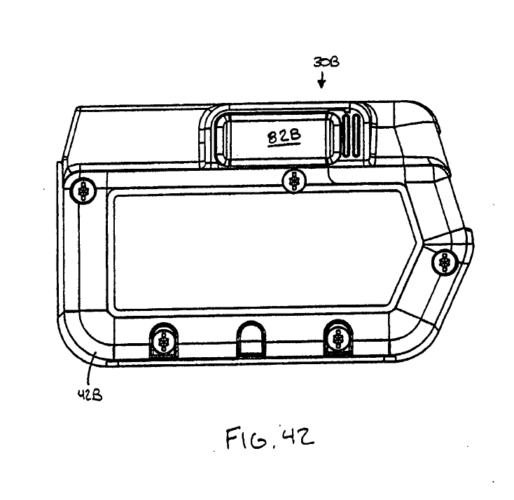

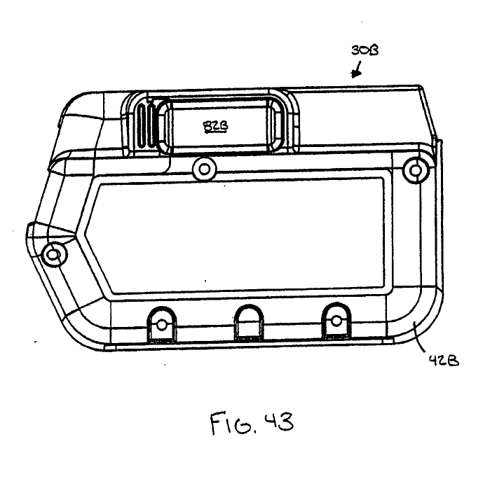

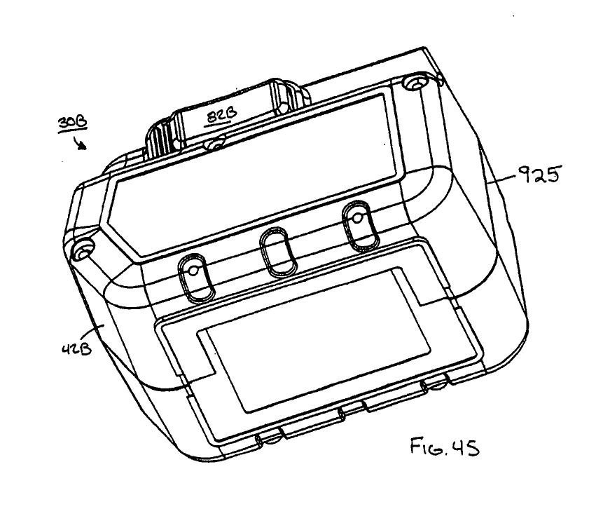

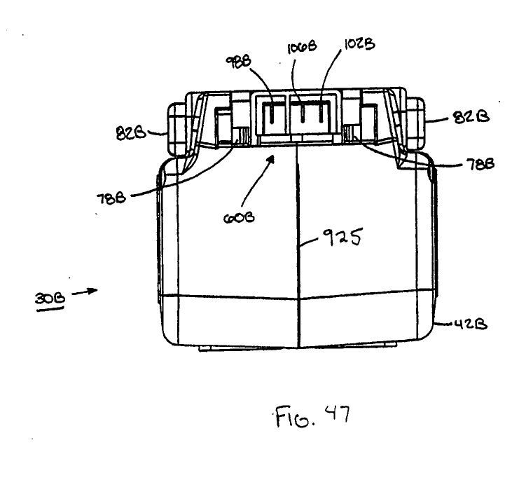

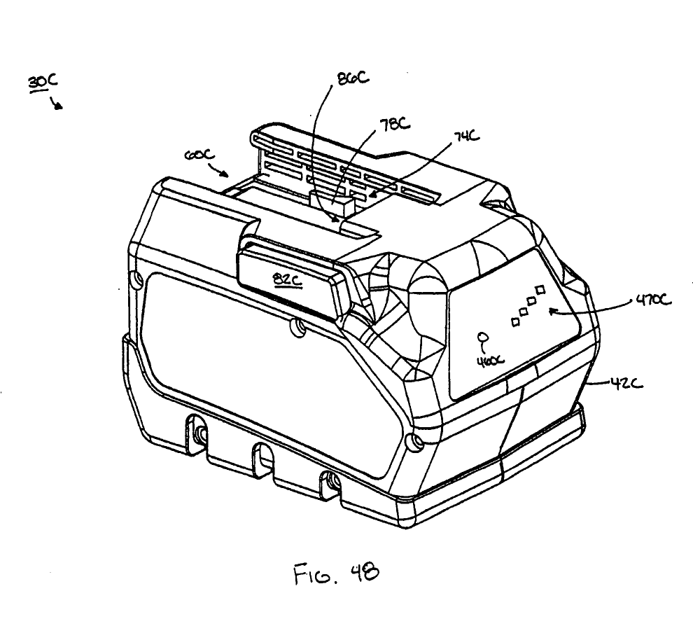

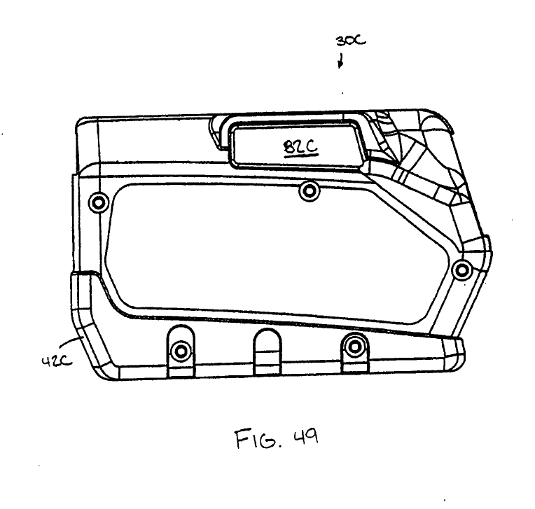

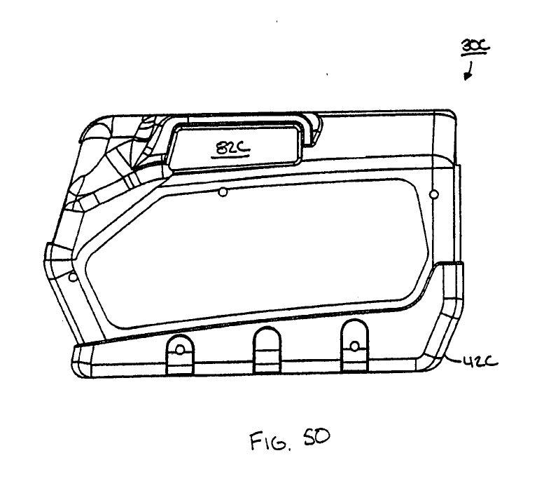

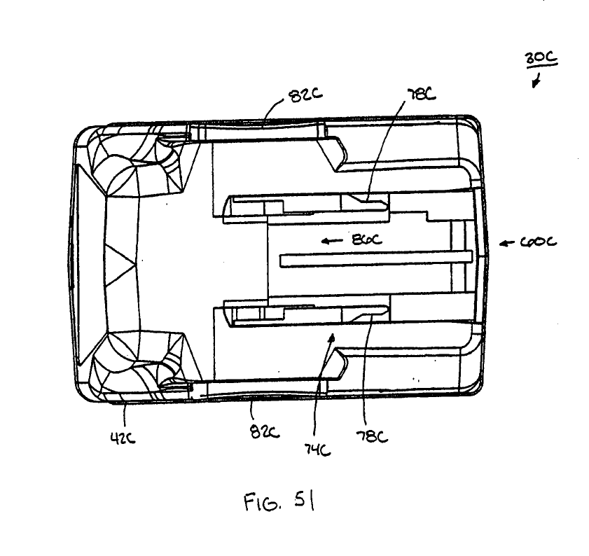

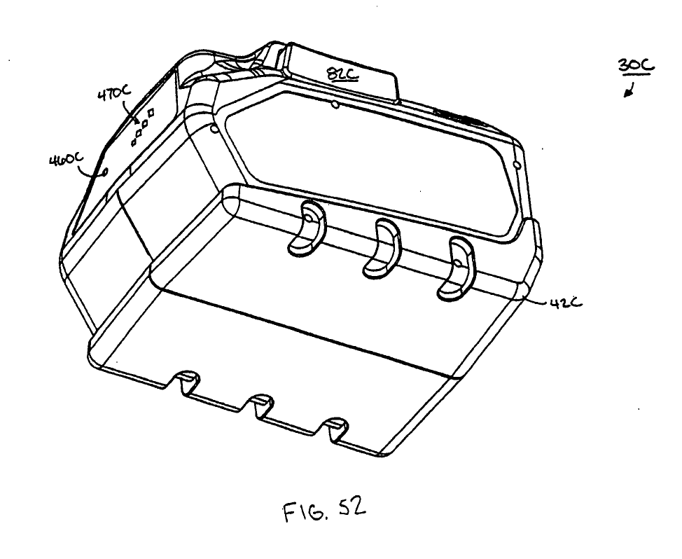

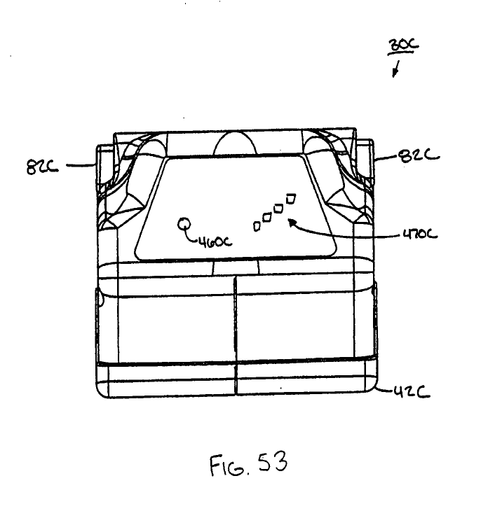

As stated previously, the battery pack 30 can include more or fewer battery cells 46 than the embodiment shown, and can have a higher or lower nominal voltage than in the constructions shown and described. For example, one such construction of a battery pack 30B having a higher nominal voltage is shown in FIGS. 41-47. Common elements are identified by the same reference number “B”. A further construction of a battery pack 30C is shown in FIGS. 48-54. Common elements are identified by the same reference number “C”.

Unless specified otherwise, hereinafter, battery pack 30 can refer to the various constructions of battery pack 30 (e.g., battery pack 30, battery pack 30A, battery pack 30B, battery pack 30C and battery pack 30D). Also, unless specified otherwise, battery pack 30B can refer to battery pack 30B, battery pack 30C and battery pack 30D.

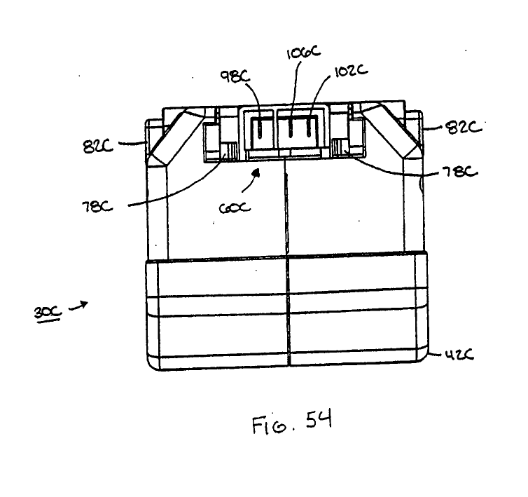

In some constructions, the battery pack 30 can be configured for transferring power to and receiving power from various electrical devices, such as, for example, various power tools, battery chargers, and the like. In other constructions, the battery pack 30 can be configured for transferring power to various high-power electrical devices, such as, for example: various power tools and including electrically powered tools used in manufacturing and assembly; lawn and garden equipment and including tools used in agricultural applications; portable lighting, signaling devices, and flashlights; motorized vehicles including electrically powered scooters, mopeds, motorized carts, and the like; vacuum cleaners and other electrically powered household and commercial applications, tools, and devices; electrically powered toys; remote-controlled airplanes, automobiles, and other vehicles as well as auxiliary motors and the like. In some constructions, such as, for example, the constructions illustrated in FIGS. 55 and 56, the battery pack 30 can supply power to various power tools, such as, a driver drill 300, a circular saw 305, band saw (not shown), grinder (not shown) and the like. In some constructions, the battery pack 30 can power various power tools (including a driver drill 300 and a circular saw 305) having high discharge current rates. For example, the battery pack 30 can supply an average discharge current that is equal to or greater than approximately 20 A, and can have an ampere-hour capacity of approximately 3.0 A-h. In other constructions, the battery pack 30 can supply an average discharge current that is equal to or greater than approximately 10 A. In further constructions, the battery pack 30 can supply an average discharge current that is equal to or greater than approximately 15 A. In still further constructions, the battery pack 30 can have a different ampere-hour capacity, such as, for example, approximately 2.5 A-h or approximately 2.8 A-h for battery cells 46 arranged in series or approximately 1.3 A-h or approximately 1.5 A-h for battery cells 46 arranged in parallel.

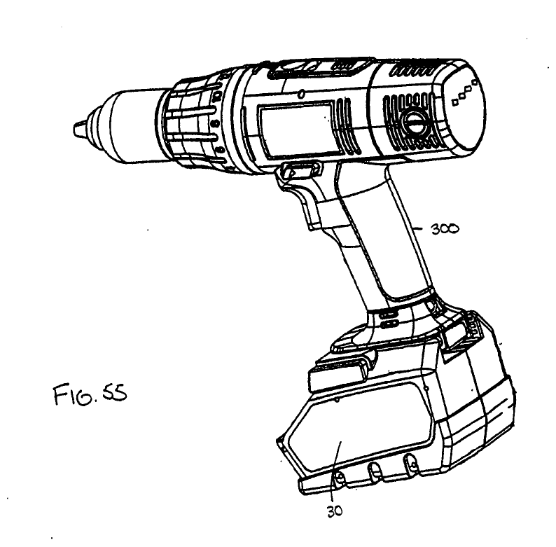

In some constructions, the battery pack 30, such as battery pack 30B, can include seven battery cells 346a-g (shown in FIG. 57). In some constructions, the battery cells 346a-g can be similar to battery cells 46a-e included in the battery pack 30. In some constructions, the battery cells 346a-g can differ from battery cells 46a-e in weight, size, nominal voltage, chemistry, and the like. For example, in one construction, the battery cells 346a-g can have a cell chemistry of Li-ion, such as, for example, Li—Mn spinel, Li—Mn nickel, or Li—Co. In some constructions, each cell 346a-g can have a nominal voltage of approximately 3.6 V, 4 V, or 4.2 . In some constructions, the battery pack 30B can include seven battery cells 346a-g, and can have a nominal voltage of approximately 25 V to 28 V. In other constructions, the battery pack 30D can include five battery cells 346a-e, and can have a nominal voltage of approximately 18 V to 21 V.

The battery cells 346a-g can also be electrically connected in any suitable manner, such as, for example, in a serial arrangement, a parallel arrangement, a partial serial arrangement (e.g., some of the battery cells 346a-g are connected in a serial arrangement), a partial parallel arrangement (e.g., some of the battery cells 346a-g are connected in a parallel arrangement), a combination of a serial, parallel, partial serial or partial parallel arrangement. In one construction, the battery cells 346a-g are electrically connected in a serial arrangement. The battery cells 346a-g can be electrically connected via conductive straps 450. For example, a conductive strap 450 can connect the negative end of the first battery cell 346a to the positive end of the second battery cell 346b. Also, another conductive strap 450 can connect the negative end of the second battery cell 346b to the positive end of the third battery cell 346c.

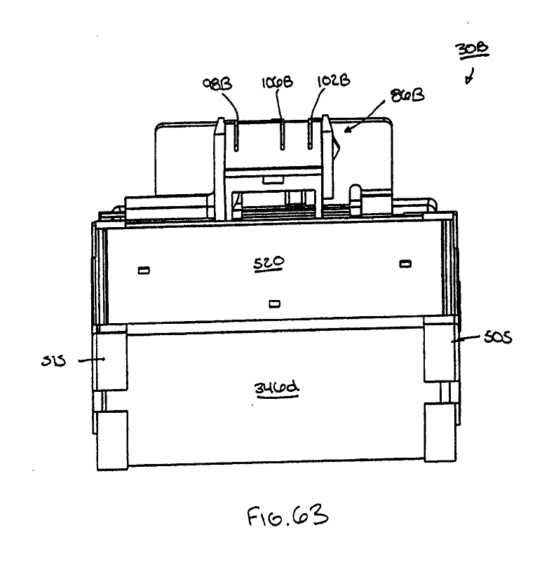

As shown in FIGS. 58-65, the battery pack 30, such as battery pack 30B, can also include an end cap arrangement 505. In some constructions, the end cap arrangement can be used for spacing the battery cells 346. The end cap arrangement 505 includes a first end cap 510 and a second end cap 515. The first and second end caps 510 and 515 can be connected by a connecting portion 520. In some constructions, the connecting portion 520 can be a hinge. In some constructions, the end cap arrangement 505 does not include the connecting portion 520. Each end cap 510 and 515 can partially define one or more cavities 530 (shown in FIG. 65). The end of a battery cell 346 can be positioned within a cavity 530. In the illustrated construction, the first end cap 510 and the second end cap 515 each include seven cavities 530a-g for positioning seven battery cells 346a-g, respectively.

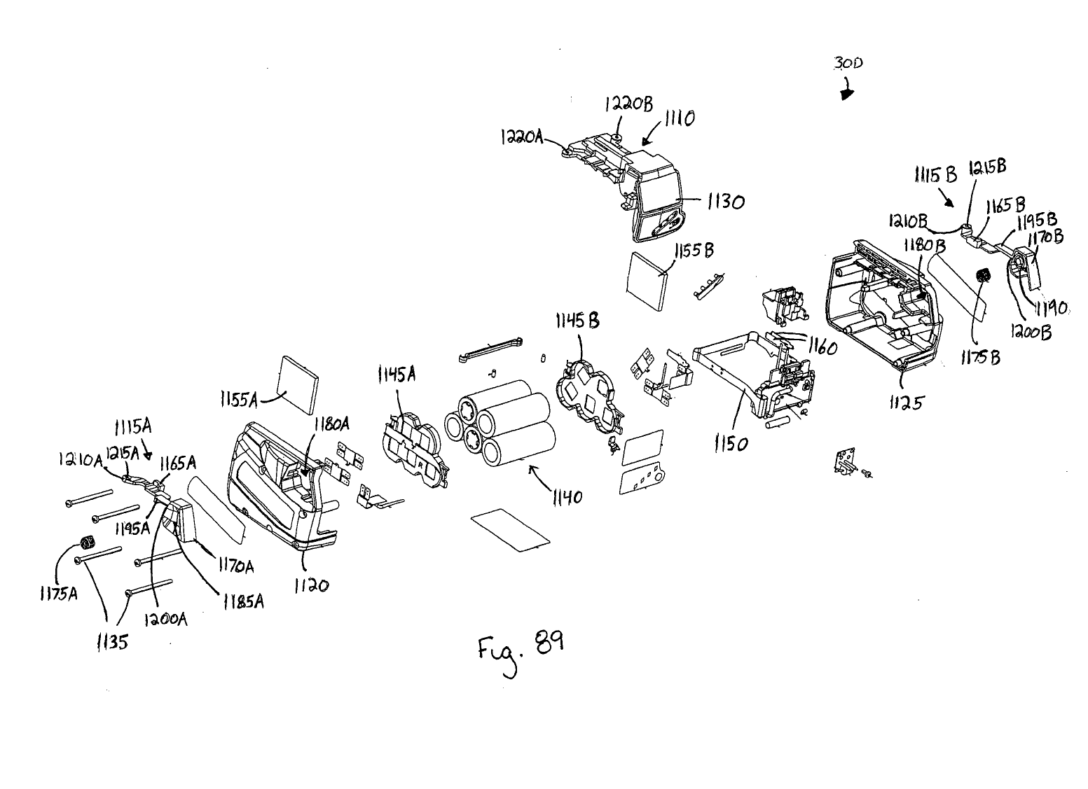

In some constructions, the cavities 530a-g can include blue foam pads 915 and 920 (shown in FIG. 73). The foam pads are positioned against the inner faces of the end caps 510 and 515 and provide a barrier between the battery cells 346a-g and the end caps 510 and 515. They are constructed from blue closed cell foam and prevent fluid materials from accessing the battery cells 346a-g or the cavities 530a-g through the end caps 510 and 515. In other constructions, such as the construction shown in FIG. 89, the foam pads 915 and 920 can be positioned against the outer faces of the end caps 510 and 515. In still further constructions, the foam pads 915 and 920 can form a single pad and wrap around the end cap arrangement 505 or wrap around the inside of the housing 42B.

In the illustrated construction, the first end cap 510 is positioned at a first end 490 (shown in FIG. 57) of the arrangement of battery cells 346, and the second end cap 515 is positioned at the second end 495 of the arrangement of battery cells 346. As mentioned previously, each end of each battery cell 346a-g can be positioned within the respective cavities 530a-g of the first and second end cap 510 and 515. Each end cap 510 and 515 can define the cavities 530a-g in order to create gaps or spaces between the battery cells 346 when the battery cells 346 are positioned within the cavities 530. This can allow for greater heat dissipation within the battery pack 30B by allowing air to circulate through the gaps and spaces between the cells 346.

In some constructions, the first end cap 510 and the second end cap 515 can further define apertures 450. The apertures 450 can receive the conductive straps 450 for electrically connecting one battery cell 346 to another battery cell 346.

In some constructions and in some aspects, the end cap arrangement 505 can also include a flexible circuit 445. In some constructions, the flexible circuit 445 can be integral with either the first end cap 510, the second end cap 515, the connecting portion 520, or a combination. In other constructions, the end cap arrangement 505 can define one or more areas for supporting the flexible circuit. In further constructions, the flexible circuit 445 can be secured to the end cap arrangement 505. As shown in the illustrated construction, the flexible circuit 445 can partially wrap around the battery cells 346.

In the construction shown, the end cap arrangement 505 can include a connector 560 for electrically connecting the flexible circuit 445 to the PCB 145B. In this construction, the PCB 145B and the flexible circuit 445 each can include a portion of the circuit 430 included in the battery pack 30B.

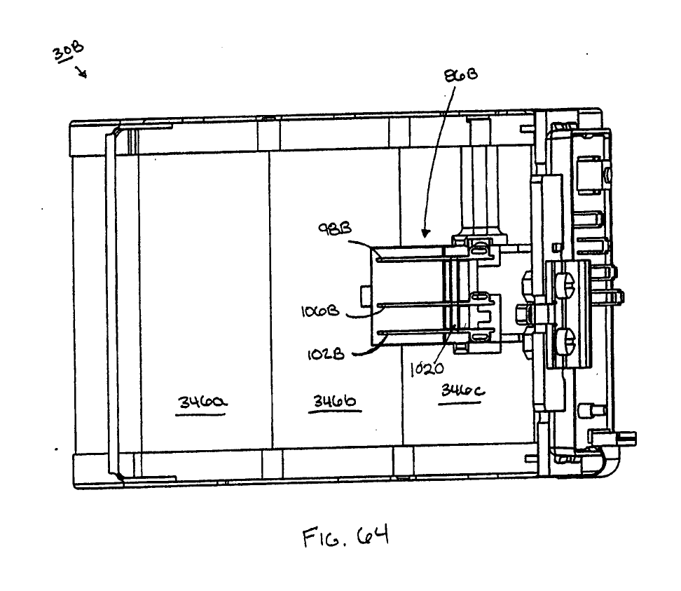

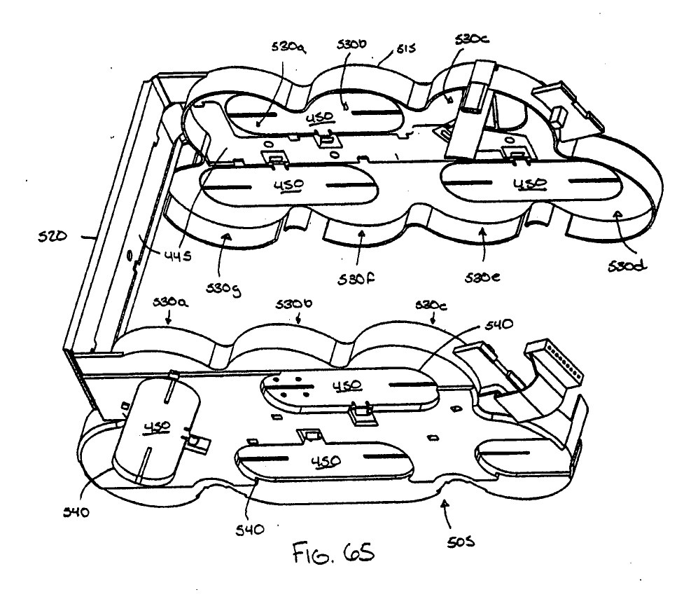

In some constructions and in some aspects, the battery pack 30 can include cushion members or “bumpers” 640. As shown in FIGS. 66 and 67, the interior face 645 of the battery housing 42B can include one or more cushion members 640. In some constructions, the cushion members 640 can be integral with the housing 42B. In other constructions, the cushion members 640 can be attached or secured to the interior face 645 of the housing 42B. In further constructions, the cushion members 640 can be connected to one or more battery cells 346 or to the end cap arrangement 505 partially surrounding the battery cells 346. In some constructions, the cushion members 645 can absorb energy during impact and protect the battery cells 346 during impact by limiting the amount of energy transferred to the cells 346. The cushion members 645 can include any thermoplastic rubber such as, for example, polypropylene RPT 100 FRHI (e.g., flame retardant-high impact).

FIG. 72 depicts a graph 900 illustrating the performance of two battery packs during a cutting test. The test includes continuous cross cutting of 2″×21″ pine with a cordless circular saw. In this construction, a first battery pack (not shown) includes five (5) Li—Mn Spinel battery cells, each having a 4.0 V nominal voltage and a 3 Ah capacity. Also in this construction, a second battery pack (not shown) includes fifteen (15) NiCd battery cells, each having a 1.2 V nominal voltage and a 2.4 Ah capacity. In this construction, the first battery pack is capable of approximately 40% more work and weighs approximately 35% less than the second battery pack. The graph 900 illustrates the pack voltage for each battery pack. The first curve 905 illustrates the voltage for the first battery pack. The second curve 910 illustrates the voltage for the second battery pack. As shown from the graph 900, the voltage 905 of the first battery pack remains steady and flat longer than the voltage 910 of the second battery pack. Thus, the first battery pack, which includes Li-ion cells, is able to maintain its voltage during discharge, as opposed to the second battery pack, which includes NiCd cells.

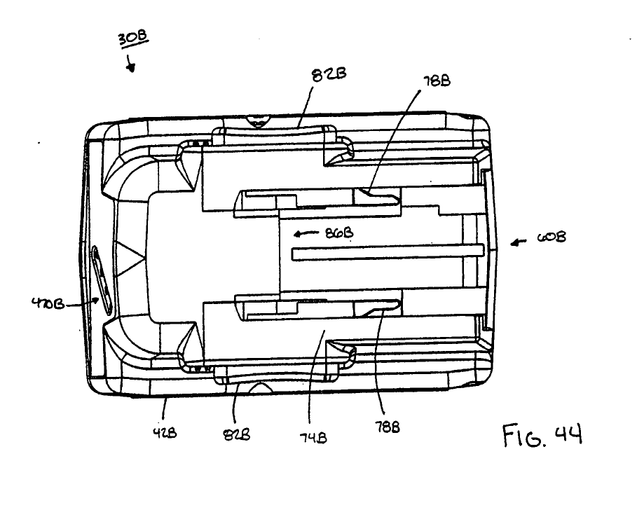

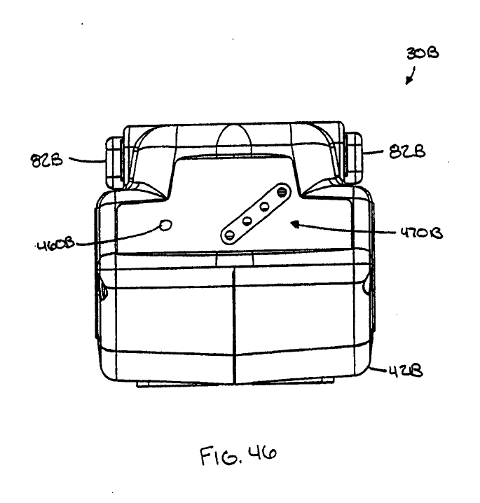

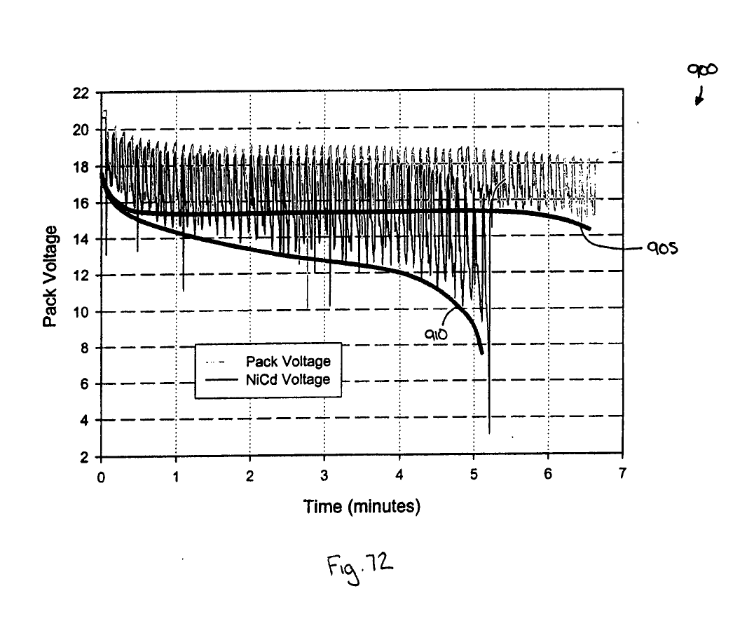

In some constructions, such as the constructions shown in FIGS. 45 and 47, the housing 42B of the battery pack 30B can have a vertical parting line 925 defining two portions (a left housing portion and a right housing portion) of the housing 42B. In other constructions, such as the constructions shown in FIGS. 74 and 75, the housing 42B of the battery pack 30B can have a horizontal parting line 930 defining two portions (an upper housing portion and a lower housing portion) of the housing 42B. Positioning the parting line in the horizontal position may help prevent water from entering the battery pack 30B when the battery pack 30B is exposed to such an environment.

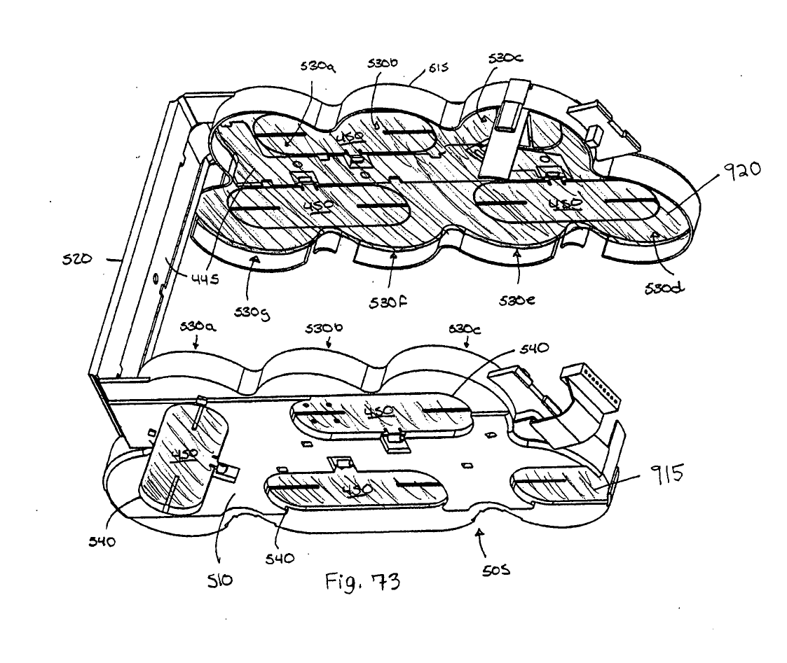

In some constructions and in some aspects, such as the construction shown in FIG. 76, each of the battery cells 346a-g can include a sleeve 935 as the outermost layer. The sleeve can serve as protection for the battery cells 346a-g, which fit into plastic end caps 510 and 5l5. The sleeves 935 of the battery cells 346a-g can be constructed of cardboard, plastic, a combination of the two or the like. In one construction, the sleeve 935 includes a thin layer of plastic or plastic and cardboard wrapped around the battery cells 346. The battery cell 346 and sleeve 935 can fit into the end caps 510 and 515. The sleeve 935 can prevent fluids from leaking in through the side walls of the battery cells 346a-g.

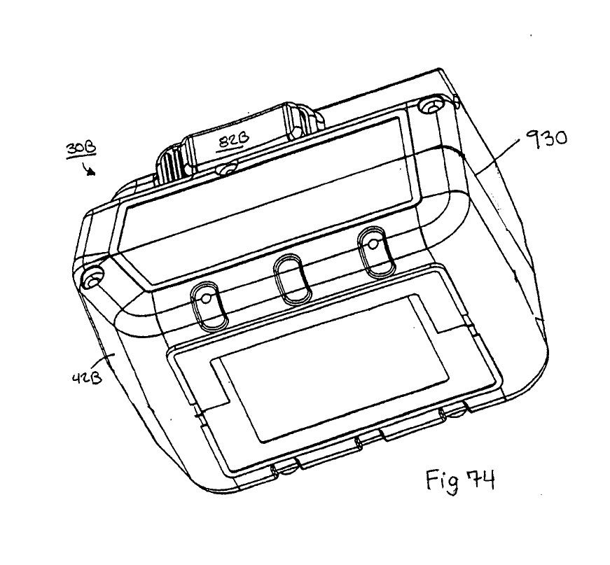

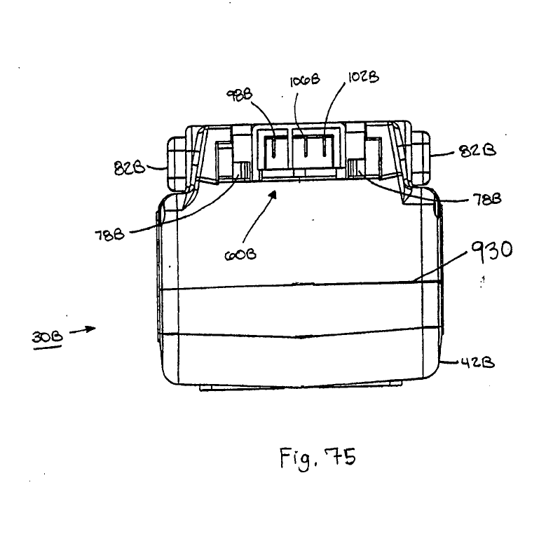

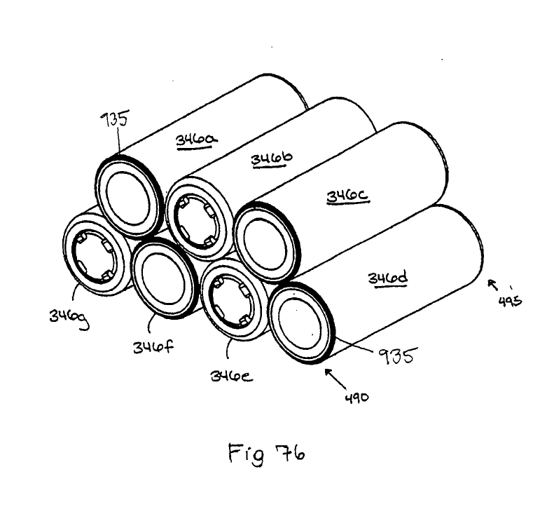

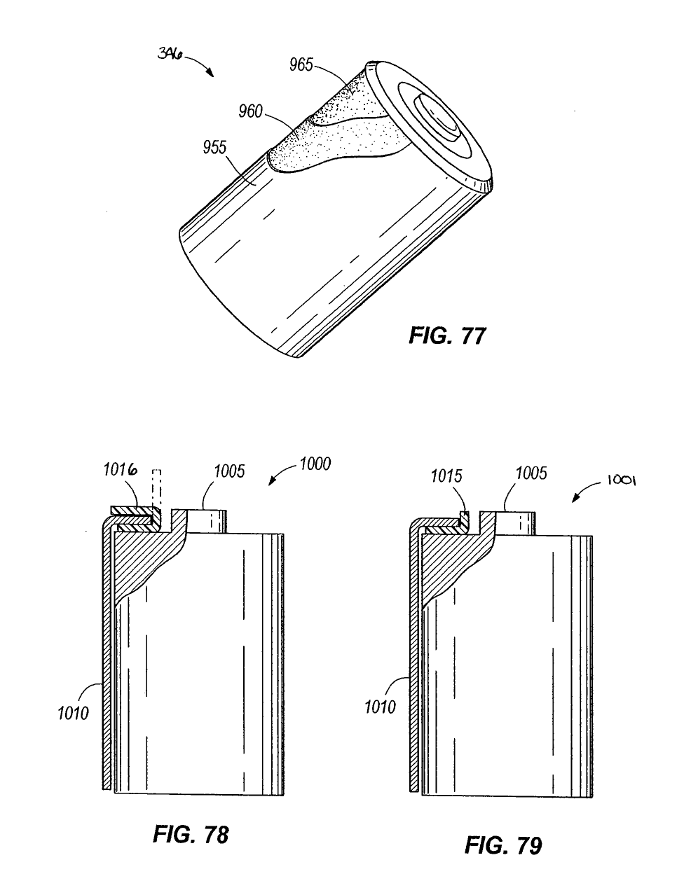

In other constructions, such as the construction shown in FIG. 77, the sleeves 935 on the battery cells 346a-g can be composed of nonconductive layers and a paper layer. The nonconductive layers 955 and 965 can be constructed from materials such as Mylar, vinyl wax or the like. The nonconductive layers 955 and 965 surround a paper layer 960 and protect the battery cells 346a-g from water damage. The sleeve 935 can make it difficult for water to penetrate through the nonconductive materials.

In some constructions and in some aspects, such as the construction shown in FIG. 78, a battery cell 1000 can include an extended plastic seal 1016 to protect the cell from water damage. A construction of a battery cell 1000 with a non-extended plastic seal 1015 is shown in FIG. 79. In this construction, it is possible for a water droplet to be in contact with both the positive electrode (header) 1005 and the negative electrode (can) 1010 of the battery cell 1001 at the same time. This could result in shorting the battery cell 1001 which can damage and quickly drain the cell 1001. In the constructions shown in FIG. 78, the extended plastic seal 1016 is extended and then folded over the can 1010. This makes it more difficult for a water droplet to be in contact with both the header 1005 and can 1010 of the battery cell 1000 at the same time.

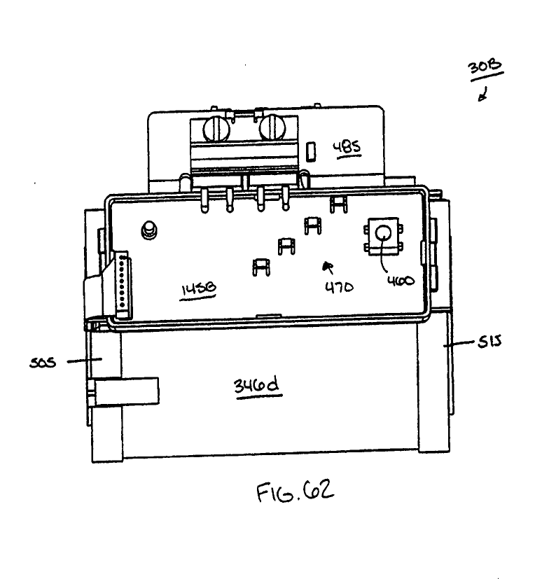

In some constructions, such as the construction shown in FIG. 80, the terminal block 86B of the battery pack 30B can be protected against water damage. If water enters the battery pack 30B, water may collect on a terminal block causing the terminals to short. As shown in FIG. 64, the terminal block 86B can include a groove 1020. If water collects in the groove 1020, the battery pack 30B can be shorted. To prevent shorting from occurring, the groove can be filled with a non-conductive material in between the terminals, as shown in FIG. 80.

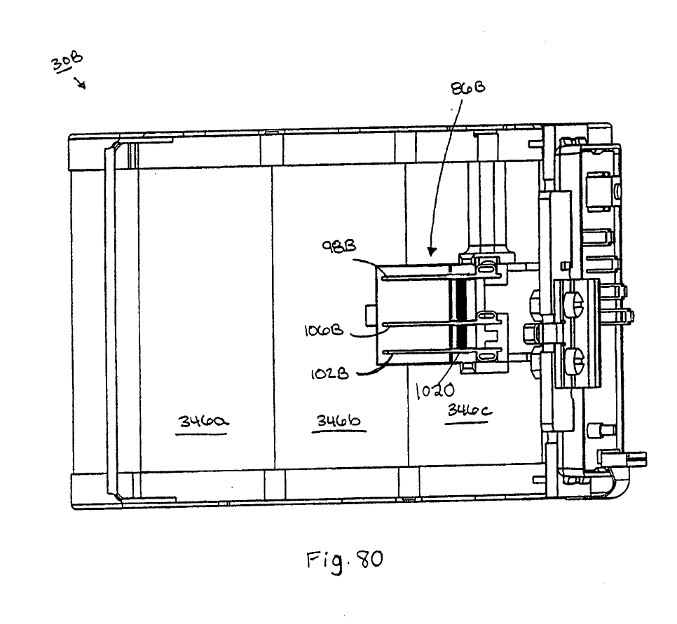

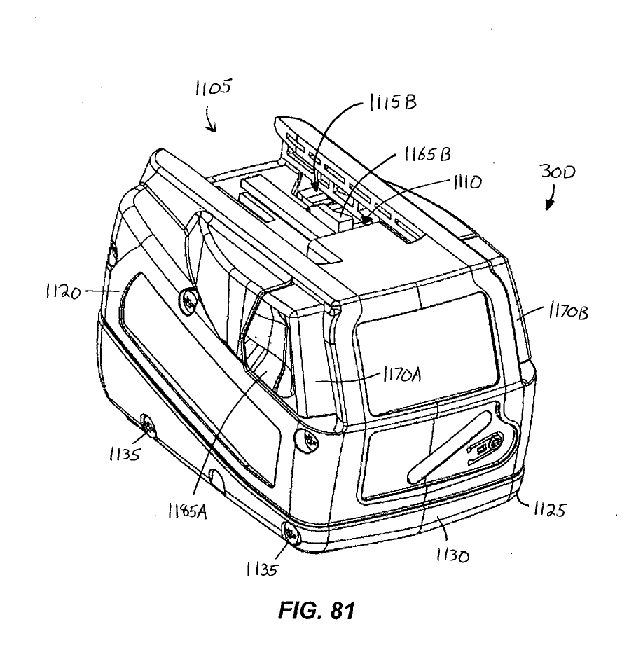

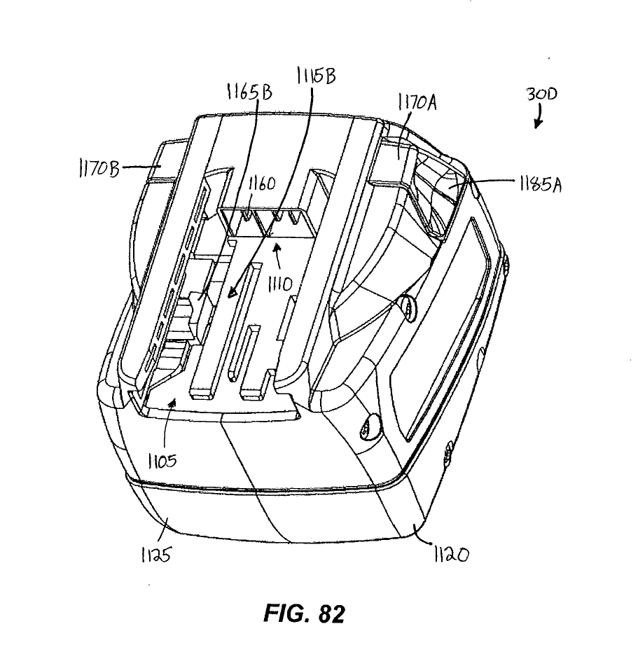

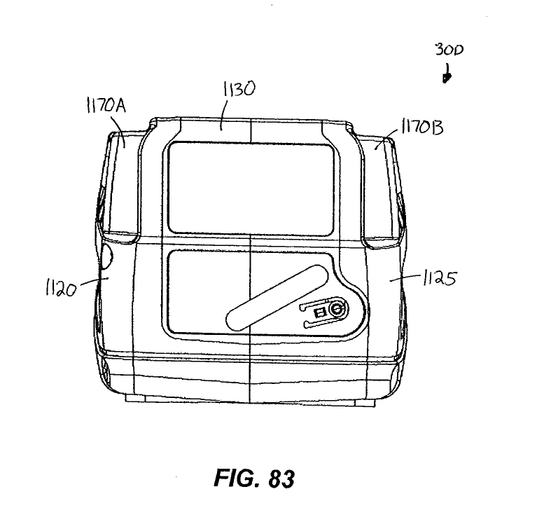

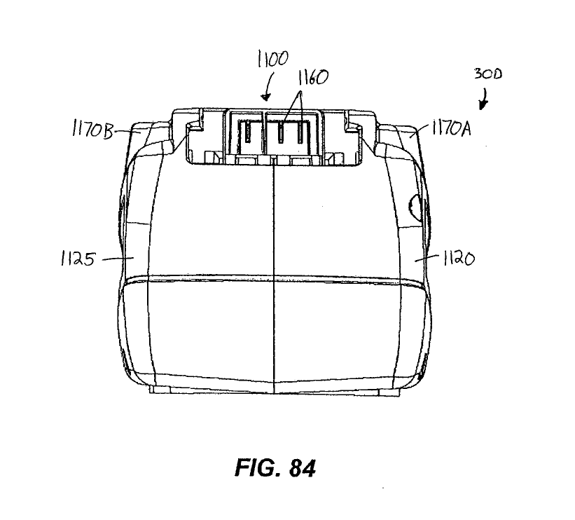

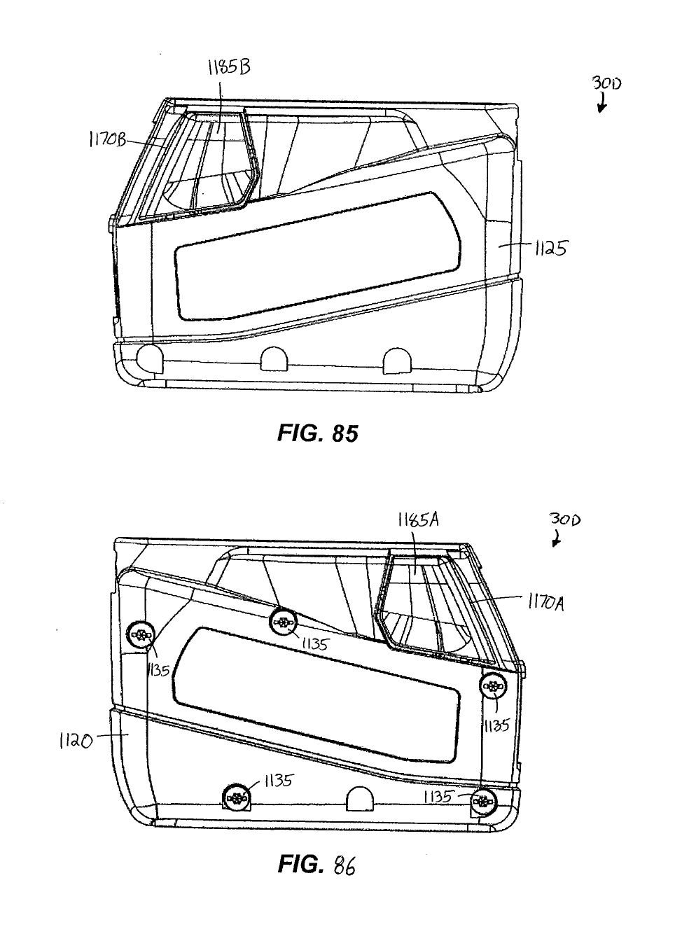

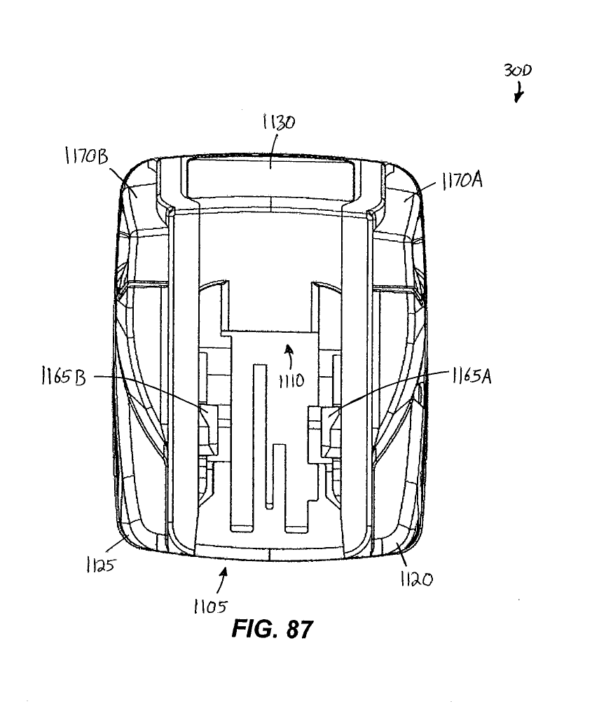

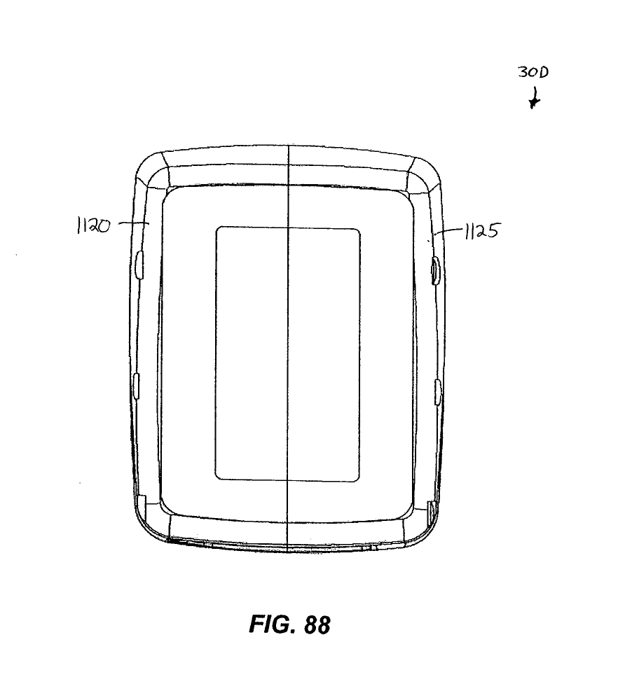

A further construction of a battery pack 30D is shown in FIGS. 81-91. The battery pack 30D includes a groove 1105, a terminal assembly 1110, a first locking assembly 11 15A, and a second locking assembly 11 15B. The groove 1105 facilitates coupling of the battery pack 30D to an electrical device, such as, for example, a power tool and/or a battery charger. In the illustrated embodiment, the battery pack 3 OD is slidable onto the electrical device such that the groove 11 05 engages a corresponding support portion on the electrical device (e.g., 186A shown in FIG. 11A, 124 shown in FIG. 12). In addition, sliding the battery pack 30D onto the electrical device moves the terminal assembly 1110 into electrical contact with a corresponding terminal assembly on the electrical device (e.g., 186B shown in FIG. 11B, 128 shown in FIG. 12). The first and second locking assemblies 1115A, 1115B are operable to lock the battery pack 30D to the electrical device when the battery pack 30D is substantially slid onto the electrical device.

As shown in FIG. 89, the battery pack 30D includes a first housing portion 1120, a second housing portion 1125, and a third housing portion 1130. Fasteners 1135 (e.g., bolts, screws, etc.) secure the housing portions 1120, 1125, 1130 together to enclose a plurality of battery cells 1140.

In the illustrated embodiment, five battery cells 1140 are positioned between a pair of end caps 1145A, 1145B and supported within a frame 1150. Foam pads 1155A, 1155B are positioned between the end caps 1145A, 145B and the battery cells 1140 and function similarly to the foam pads 915, 920 discussed above with reference to FIG. 73. Terminals 1160 extend upward from the frame 1150 and into the third housing portion 1130 as part of the terminal assembly 1110. The terminals 1160 provide electrical contact between the battery cells 1140 and the electrical device to transfer power, similar to the terminals 98, 102, 106 discussed above.

Each locking assembly 1115A, 1115B includes a locking member 1165A, 1165B movable between a locked position, in which the locking member 1165A, 1165B engages a corresponding locking member or recess on an electrical device to lock the battery pack 30D to the electrical device, and an unlocked position. In the illustrated embodiment, the locking members 1165A, 1165B are tapered to facilitate sliding of the battery pack 30D onto the electrical device without requiring a user to move the locking members 1165A, 1165B toward the unlocked position.

Each locking assembly 1115A, 1115B also includes an actuator 1170A, 1170B to move the corresponding locking member 1165A, 1165B between the locked position and the unlocked position and a biasing member 1175A, 1175B (e.g., a coil spring) to bias the corresponding locking member 1165A, 1165B to the locked position. The actuators 1170A, 1170B partially extend through respective apertures 1180A, 1180B in the first and second housing portions 1120, 1125. In the illustrated construction, each actuator 1170A, 1170B has a grooved surface 1185A, 1185B (e.g., ergonomic, ridged, contoured, etc.) to facilitate engagement by an operator and provide improved ease of unlocking the locking assemblies 1115A, 1115B.

Referring to the second locking assembly 1115B shown in FIG. 89, the biasing member 1175B is positioned between a backside 1190 (e.g., the side opposite the grooved surface 1185B) of the actuator 1170B and the second housing portion 1125. The biasing member 1175B engages the actuator 1170B to bias the actuator 1170B, and thereby the locking member 1165B, outwardly (e.g., away from) the second housing portion 1125. The other biasing member 1175A is positioned between the actuator 1170A and the first housing portion 1120 in a similar manner.

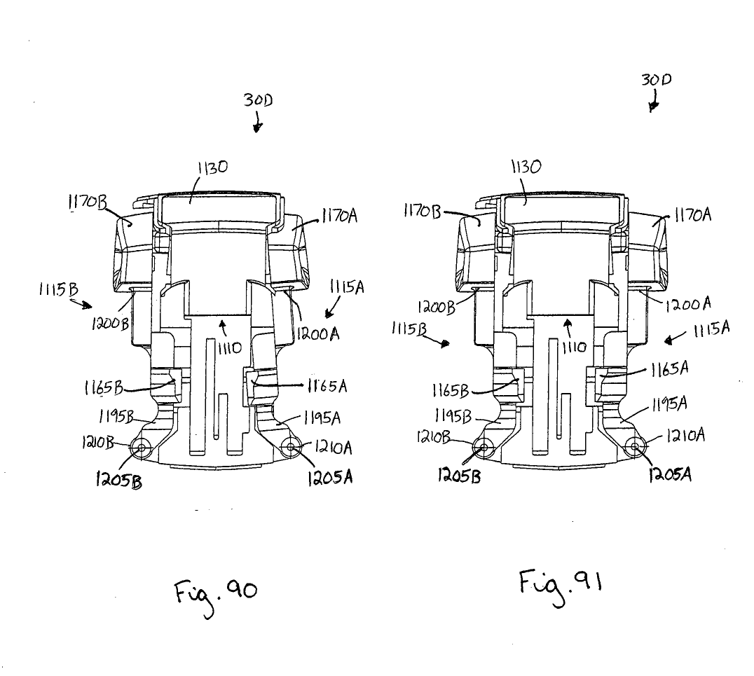

Each locking assembly 1115A, 1115B further includes an elongated member 1195A, 1195B which couples the actuator 1195A, 1195B to the locking member 1165A, 1165B. The locking member 1165A, 1165B is positioned approximately in the middle of the elongated member 1195A, 1195B, and the actuator 1170A, 1170B is positioned at a first end 1200A, 1200B of the elongated member 1195A, 1195B. The elongated member 1195A, 1195B can pivotally move about a pivot point 1205A, 1205B (see FIGS. 90 and 91) proximate a second end 1210A, 1210B of the elongated member 1195A, 1195B. A bore 1215A, 1215B provided at the second end 1210A, 1210B of each elongated member 1195A, 1195B corresponds to a bore 1220A, 1220B provided on the third housing 1130. A rod or pin (not shown) is positioned within the bores 1215A, 1215B, 1220A, 1220B to define the pivot point 1205A, 1205B about which the elongated member 1195A, 1195B pivots.

FIGS. 90 and 91 illustrate a top view of the battery pack 30D without the first and second housing portions 1120, 1125. In FIG. 90, the first locking assembly 1115A is in the unlocked position while the second locking assembly 1115B is in the locked position. In FIG. 91, the first and the second locking assemblies 1115A, 1115B are both in the locked position.

When a user depresses the actuators 1170A, 1170B (e.g., pushes the actuators 1170A, 1170B inwardly), the elongated members 1195A, 1195B, and likewise the locking members 1165A, 1165B, pivot about the respective pivot points 1205A, 1205B to move the locking members 1165A, 1165B to the unlocked position. Moving the locking members 1165A, 1165B to the unlocked position unlocks the locking members 1165A, 1165B from the corresponding locking members or recesses of the electrical device. While the locking members 1165A, 1165B are in the unlocked position, the battery pack 30D may be decoupled and slid apart from the electrical device.

It should be understood that the relative positions of the actuators 1170A, 1170B, the locking members 1165A, 1165B, and the pivot points 1205A, 1205B relative to the elongated members 1195A, 1195B may be different. For example, in other constructions (not shown) an actuator and a locking member may be positioned relatively close to one another (e.g., both proximate to the first end of the elongated member) such that pivoting movement of the actuator causes a similar amount of pivoting movement of the locking member.

Also, in yet other constructions (not shown), an actuator may be positioned between a locking member and a pivot point such that movement of the actuator causes a greater amount of movement of the locking member (e.g., the actuator must only be moved a small amount to move the locking member a relatively large amount).

In addition, in further constructions (not shown), a pivot point may be positioned between an actuator and a locking member (e.g., as a two-arm lever) such that pivoting movement of the actuator in one direction (e.g., inwardly) causes pivoting movement of the locking member in an opposite direction (e.g., outwardly). Such an arrangement may be based on a desired movement of the actuators (e.g., squeezed together by an operator) and a desired resulting unlocking movement of the associated locking members (e.g., moved outwardly, away from a corresponding recess).

Various features and advantages of the invention are set forth in the following claims.

What is claimed is:

1. A battery pack configured to be coupled to an electrical device, the battery pack comprising:
a housing;
at least one battery cell positioned in the housing;
a terminal assembly configured to electrically connect the battery cell to the electrical device; and
a locking assembly configured to engage the electrical device, the locking assembly including
a locking member movable about a pivot point between a first position to engage the electrical device and a second position,
an actuator coupled to the locking member and actuatable to move the locking member from the first position to the second position, and
a biasing member to bias the locking member to the first position.

2. The battery pack of claim 1, and further comprising a second locking member movable between a first position to engage the electrical device and a second position, and a second actuator coupled to the second locking member and actuatable to move the second locking member to the second position.

3. The battery pack of claim 2, and further comprising a second biasing member to bias the second locking member to the first position.

4. The battery pack of claim 1, wherein the housing is configured to slide relative to the electrical device when the locking member is in the second position, such that the battery pack can be decoupled from the electrical device.

5. The battery pack of claim 1, wherein the locking member is positioned between the actuator and the pivot point.

6. The battery pack of claim 1, wherein the actuator is positioned between the locking member and the pivot point.

7. The battery pack of claim 1, wherein the pivot point is positioned between the locking member and the actuator.

8. The battery pack of claim 1, wherein the actuator includes a grooved surface to facilitate actuation by a user.

9. A system comprising:
an electrical device having a support portion and a circuit, the support portion defining at least one recess; and
a battery pack configured to be selectively coupled to the electrical device, the battery pack including
a housing,
at least one battery cell positioned in the housing,
a terminal assembly configured to electrically connect the at least one battery cell to the circuit,
at least one locking member movable about a pivot point between a first position to engage the at least one recess and a second position,
at least one actuator actuatable to move the at least one locking member from the first position to the second position, and
at least one biasing member to bias the at least one locking member to the first position.

10. The system of claim 9, wherein the housing is configured to slide relative to the electrical device when the at least one locking member is in the second position, such that the battery pack can be decoupled from the electrical device.

11. The system of claim 9, wherein the at least one actuator includes a grooved surface to facilitate actuation by a user.

12. The system of claim 9, wherein the electrical device further has a motor electrically coupled to the circuit, wherein the circuit is configured to selectively transfer power from the battery pack to the motor.

13. The system of claim 9, wherein the electrical device is a battery charger.

14. The system of claim 9, wherein the electrical device is a power tool.
